(19) United States
(12) Patent Application Publication
(10) Pub. No.: US 2026/0113474 A1
(43) Pub. Date: Apr. 23, 2026

(54) VIDEO DECODING METHOD AND APPARATUS, AND DEVICE AND STORAGE MEDIUM

(71) Applicant: GUANGDONG OPPO MOBILE TELECOMMUNICATIONS CORP., LTD., Dongguan (CN)

(72) Inventor: Fan WANG, Dongguan (CN)

(21) Appl. No.: 19/428,443

(22) Filed: Dec. 22, 2025

Related U.S. Application Data
(63) Continuation of application No. PCT/CN2023/105570, filed on Jul. 3, 2023.

(51) Int. Cl. H04N 19/44; H04N 19/137; H04N 19/176

(52) U.S. Cl. CPC H04N 19/44; H04N 19/137; H04N 19/176

(57) ABSTRACT

A video decoding method includes: determining first motion information of a current block; refining the first motion information based on motion information of a reference picture of the current block to obtain second motion information of the current block; and determining a prediction value of the current block based on the second motion information.

### CROSS-REFERENCE TO RELATED APPLICATION

This application is a Continuation Application of International Application No. PCT/CN2023/105570 filed on Jul. 3, 2023, which is incorporated herein by reference in its entirety.

### TECHNICAL FIELD

The present disclosure relates to the field of video encoding and decoding technology, and in particular, to a video decoding method and apparatus, a device, and a storage medium.

### BACKGROUND

Digital video technologies may be incorporated into a variety of video apparatuses, such as a digital television, a smartphone, a computer, an e-reader, or a video player, etc. With the development of video technologies, the amount of data included in video data is larger, and in order to facilitate the transmission of the video data, a video apparatus performs the video compression technology to enable more efficient transmission or storage of the video data.

Since there is a temporal or spatial redundancy in the video, the redundancy in the video may be eliminated or reduced through prediction and thus the compression efficiency is improved. In the prediction, in order to improve decoding accuracy, a decoder side refines motion information determined by decoding. However, current motion information refinement methods have poor refinement effects, resulting in the prediction of the decoder side being not accurate enough, thereby affecting the decoding performance of the video.

### SUMMARY

The embodiments of the present disclosure provide a video decoding method and apparatus, a device, and a storage medium.

In a first aspect, the present disclosure provides a video decoding method, which is applied to a decoder and includes:
determining first motion information of a current block;
refining the first motion information based on motion information of a reference picture of the current block to obtain second motion information of the current block; and
determining a prediction value of the current block based on the second motion information.

In a second aspect, the present disclosure provides a video decoding apparatus, which is configured to perform the method in the above-mentioned first aspect or various implementations thereof. Exemplarily, the apparatus includes a functional unit for performing the method in the above-mentioned first aspect or various implementations thereof.

In a third aspect, a video decoder is provided and includes a processor and a memory. The memory is configured to store a computer program, and the processor is configured to call and run the computer program stored in the memory to perform the method in the above-mentioned first aspect or various implementations thereof.

In a fourth aspect, a video encoding and decoding system is provided and includes a video encoder and a video decoder. The video decoder is configured to perform the method in the above-mentioned first aspect or various implementations thereof.

In a fifth aspect, a chip is provided for implementing the method of the above-mentioned first aspect. Exemplarily, the chip includes: a processor, configured to call and run a computer program from a memory to cause a device installed with the chip to perform the method according to the above-mentioned first aspect.

In a sixth aspect, a non-transitory computer-readable storage medium is provided for storing a computer program, and the computer program causes a computer to perform the method in the above first aspect.

In a seventh aspect, a computer program product is provided, and includes computer program instructions, and the computer program instructions cause a computer to perform the method in the above first aspect.

### BRIEF DESCRIPTION OF THE DRAWINGS

FIG. 1 is a schematic block diagram of a video encoding and decoding system involved in the embodiments of the present disclosure.

FIG. 2 is a schematic block diagram of a video encoder involved in the embodiments of the present disclosure.

FIG. 3 is a schematic block diagram of a video decoder involved in the embodiments of the present disclosure.

FIG. 4 is a structural schematic diagram of a group of pictures (GOP).

FIG. 5 is a schematic diagram of coding unit (CU) partition.

FIG. 6 is a schematic diagram of a spatial and temporal block.

FIG. 7 is a schematic diagram of deriving temporal motion information.

FIG. 8 is a schematic diagram of a principle of Subblock-based temporal motion vector prediction (SbTMVP).

FIG. 9 is a schematic diagram of a principle of Merge mode with MVD (MMVD).

FIG. 10A is a schematic diagram of a principle of Affine.

FIG. 10B is a schematic diagram of another principle of Affine.

FIG. 11 is a schematic diagram of weight allocation.

FIG. 12 is a schematic diagram of a principle of Decoder side motion vector refinement (DMVR).

FIG. 13 is a schematic diagram of template matching.

FIG. 14 is a schematic flowchart of a video decoding method provided in an embodiment of the present disclosure.

FIG. 15 is a schematic diagram of a current block and a reference block.

FIG. 16 is a schematic diagram of motion of a current block and two reference blocks.

FIG. 17A is a schematic diagram of motion in a case where motion information of the current block is greater than motion information of the reference block.

FIG. 17B is a schematic diagram of motion in a case where motion information of the current block is less than motion information of the reference block.

FIG. 18A is another schematic diagram of motion in a case where motion information of the current block is less than motion information of the reference block.

FIG. 18B is another schematic diagram of motion in a case where motion information of the current block is greater than motion information of the reference block.

FIG. 19A is a schematic diagram of searching motion information.

FIG. 19B is another schematic diagram of searching motion information.

FIG. 19C is yet another schematic diagram of searching motion information.

FIG. 20 is a schematic diagram of different motion information present in the reference block.

FIG. 21 is a schematic block diagram of a video decoding apparatus provided in an embodiment of the present disclosure.

FIG. 22 is a schematic block diagram of an electronic device provided in the embodiments of the present disclosure.

### DETAILED DESCRIPTION

The present disclosure may be applied to the field of picture encoding and decoding, the field of video encoding and decoding, the field of hardware video encoding and decoding, the field of dedicated circuit video encoding and decoding, and the field of real-time video encoding and decoding, etc. For example, solutions of the present disclosure may be combined into an audio video coding standard (AVS), such as H.264/audio video coding (AVC) standard, H.265/high efficiency video coding (HEVC) standard, and H.266/versatile video coding (VVC) standard. Alternatively, the solutions of the present disclosure may be combined into other dedicated or industrial standards for operations, and the standards contain ITU-TH.261, ISO/IECMPEG-1 Visual, ITU-TH.262 or ISO/IECMPEG-2Visual, ITU-TH.263, ISO/IECMPEG-4Visual, ITU-TH.264 (also referred to as ISO/IECMPEG-4AVC), containing scalable video coding (SVC) and multi-view video coding (MVC) extensions. It should be understood that the technology of the present disclosure is not limited to any specific coding standard or technology.

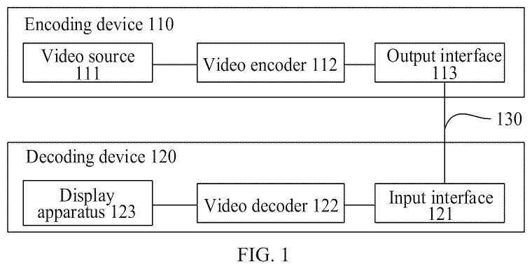

For ease of understanding, a video encoding and decoding system involved in the embodiments of the present disclosure is first introduced in combination with FIG. 1.

FIG. 1 is a schematic block diagram of a video encoding and decoding system involved in the embodiments of the present disclosure. It should be noted that FIG. 1 is only an example, and the video encoding and decoding system of the embodiments of the present disclosure includes but is not limited to that illustrated in FIG. 1. As illustrated in FIG. 1, the video encoding and decoding system 100 contains an encoding device 110 and a decoding device 120. Herein, the encoding device is used to encode video data (which may be understood as compression) to generate a bitstream, and transmit the bitstream to the decoding device. The decoding device decodes the bitstream generated by the encoding of the encoding device to obtain decoded video data.

The encoding device 110 of the embodiments of the present disclosure may be understood as a device with a video encoding function, and the decoding device 120 may be understood as a device with a video decoding function, that is, the embodiments of the present disclosure contain a wider range of apparatuses for the encoding device 110 and the decoding device 120, such as containing a smartphone, a desktop computer, a mobile computing apparatus, a notebook (e.g., laptop) computer, a tablet computer, a set-top box, a television, a camera, a display apparatus, a digital media player, a video game console, a vehicle-mounted computer, etc.

In some embodiments, the encoding device 110 may transmit the encoded video data (e.g., the bitstream) to the decoding device 120 via channel 130. Channel 130 may include one or more media and/or apparatuses capable of transmitting the encoded video data from the encoding device 110 to the decoding device 120.

In an instance, channel 130 includes one or more communication media that enable the encoding device 110 to transmit the encoded video data directly to the decoding device 120 in real-time. In this instance, the encoding device 110 may modulate the encoded video data according to a communication standard and transmit modulated video data to the decoding device 120. Herein, the communication medium contains a wireless communication medium, such as a radio frequency spectrum. Optionally, the communication medium may also contain a wired communication medium, such as one or more physical transmission lines.

In another instance, channel 130 includes a storage medium, and the storage medium may store the video data encoded by the encoding device 110. The storage medium contains a variety of locally accessible data storage media, such as an optical disk, a digital video disk (DVD), a flash memory, etc. In this instance, the decoding device 120 may acquire the encoded video data from the storage medium.

In another instance, channel 130 may contain a storage server, and the storage server may store the video data encoded by the encoding device 110. In this instance, the decoding device 120 may download the stored encoded video data from the storage server. Optionally, the storage server may store the encoded video data and may transmit the encoded video data to the decoding device 120, for example, a web server (e.g., for a website), a file transfer protocol (FTP) server, etc.

In some embodiments, the encoding device 110 contains a video encoder 112 and an output interface 113. Herein, the output interface 113 may contain a modulator/demodulator (a modem) and/or a transmitter.

In some embodiments, the encoding device 110 may also include a video source 111 other than the video encoder 112 and the output interface 113.

The video source 111 may contain at least one of: a video capturing apparatus (e.g., a video camera), a video archive, a video input interface, or a computer graphics system, where the video input interface is used to receive video data from a video content provider, and the computer graphics system is used to generate video data.

The video encoder 112 encodes the video data from the video source 111 to generate a bitstream. The video data may include one or more pictures or one or more sequences of pictures. The bitstream contains encoded information of the picture or the sequence of pictures in the form of a bit stream. The encoded information may contain encoded picture data and associated data. The associated data may contain a sequence parameter set (SPS), a picture parameter set (PPS) and other syntax structures. The SPS may contain a parameter applied to one or more sequences. The PPS may contain a parameter applied to one or more pictures. The syntax structure is a set of zero or more syntax elements arranged in a specified order in a bitstream.

The video encoder 112 transmits the encoded video data directly to the decoding device 120 via the output interface 113. The encoded video data may also be stored in the storage medium or the storage server, for subsequent reading by the decoding device 120.

In some embodiments, the decoding device 120 contains an input interface 121 and a video decoder 122.

In some embodiments, the decoding device 120 may include a display apparatus 123 other than the input interface 121 and the video decoder 122.

Herein, the input interface 121 contains a receiver and/or a modem. The input interface 121 may receive the encoded video data through the channel 130.

The video decoder 122 is used to decode the encoded video data to obtain decoded video data, and transmit the decoded video data to the display apparatus 123.

The display apparatus 123 displays the decoded video data. The display apparatus 123 may be integrated with the decoding device 120 or external to the decoding device 120. The display apparatus 123 may include various display apparatuses, such as a liquid crystal display (LCD), a plasma display, an organic light emitting diode (OLED) display, or other types of display apparatuses.

In addition, FIG. 1 is only an instance, and the solutions of the embodiments of the present disclosure are not limited to FIG. 1. For example, the technology of the present disclosure may also be applied to unilateral video encoding or unilateral video decoding.

A video encoding framework involved in the embodiments of the present disclosure is introduced below.

FIG. 2 is a schematic block diagram of a video encoder involved in the embodiments of the present disclosure. It should be understood that the video encoder 200 may be used to perform lossy compression on a picture, or may be used to perform lossless compression on a picture. The lossless compression may be visually lossless compression or may be mathematically lossless compression.

The video encoder 200 may be applied to picture data in a luma and chroma (YCbCr, YUV) format. For example, a YUV ratio may be 4:2:0, 4:2:2 or 4:4:4, where Y represents luma (Luma), Cb (U) represents blue chroma, Cr (V) represents red chroma, and U and V represent that the chroma (Chroma) is used to describe color and saturation. For example, in a color format, 4:2:0 represents that every 4 samples have 4 luma components and 2 chroma components (YYYYCbCr), 4:2:2 represents that every 4 samples have 4 luma components and 4 chroma components (YYYYCbCrCbCr), and 4:4:4 represents full sample display (YYYYCbCrCbCrCbCrCbCr).

For example, the video encoder 200 reads video data, and for each picture of the video data, partitions one picture into several coding tree units (CTUs). In some examples, a CTB may be referred to as a “tree block”, “largest coding unit” (LCU) or “coding tree block” (CTB). Each CTU may be associated with a sample block with identical size within the picture. Each sample may correspond to a luma (luminance) sample and two chroma (chrominance) samples. Thus, each CTU may be associated with one luma sample block and two chroma sample blocks. The size of one CTU is, for example, 128×128, 64×64, 32×32, etc. One CTU may be further partitioned into several CUs for encoding. The CU may be a rectangular block or a square block. The CU may be further partitioned into a prediction unit (PU) and a transform unit (TU), enabling separation of encoding, prediction and transform, and more flexible in processing. In an example, a CTU is partitioned into CUs in a quadtree manner, and a CU is partitioned into TUs and PUs in a quadtree manner.

The video encoder and the video decoder may support various PU sizes. Assuming that the size of a specific CU is 2N×2N, the video encoder and the video decoder may support a PU size of 2N×2N or N×N for intra prediction, and support symmetric PUs of 2N×2N, 2N×N, N×2N, N×N or similar sizes for inter prediction. The video encoder and video decoder may also support asymmetric PUs of 2N×nU, 2N×nD, nL×2N, and nR×2N for inter prediction.

In some embodiments, as illustrated in FIG. 2, the video encoder 200 may include: a prediction unit 210, a residual unit 220, a transform/quantization unit 230, an inverse transform/inverse quantization unit 240, a reconstruction unit 250, an in loop filter unit 260, a decoded picture buffer 270 and an entropy coding unit 280. It should be noted that the video encoder 200 may contain more, fewer or different functional components.

Optionally, in the present disclosure, a current block may be referred to as a current coding unit (CU) or a current prediction unit (PU), etc. The prediction block may also be referred to as a prediction picture block or a picture prediction block, and a reconstructed picture block may also be referred to as a reconstructed block or a picture reconstructed picture block.

In some embodiments, the prediction unit 210 includes an inter prediction unit 211 and an intra estimation unit 212. Since there is a strong correlation between adjacent samples in a frame (or referred to as a picture) of a video, an intra prediction method is used in the video encoding and decoding technology to eliminate spatial redundancy between the adjacent samples. Since there is a strong similarity between adjacent frames in a video, an inter prediction method is used in the video encoding and decoding technology to eliminate temporal redundancy between the adjacent frames, thereby improving the encoding efficiency.

The inter prediction unit 211 may be used for inter prediction, the inter prediction may include motion estimation and motion compensation. It may refer to picture information of different frames, and inter prediction uses motion information to find a reference block from a reference frame, and generates a prediction block according to the reference block, to eliminate the temporal redundancy. The frame used for inter prediction may be a P frame and/or a B frame, where the P frame refers to a forward prediction frame and the B frame refers to a bi-directional prediction frame. Inter prediction uses motion information to find a reference block from a reference picture (or referred to as reference frame) and generates a prediction block according to the reference block. The motion information includes a reference picture list in which the reference picture is located, a reference picture index, and a motion vector. The motion vector may be a whole-sample or a sub-sample. If the motion vector is a sub-sample, then it is necessary to use interpolation filtering in the reference picture to obtain a required sub-sample block. Here, a whole-sample block or sub-sample block of the reference picture found according to the motion vector is referred to as a reference block. The reference block is used as a prediction block directly in some technologies, while a prediction block is generated on the basis of processing the reference block in some technologies. The prediction block being generated on the basis of processing the reference block, may also be understood as using the reference block as a prediction block and then generating a new prediction block on the basis of processing the prediction block.

The intra estimation unit 212 only refers to information of a same frame picture to predict sample information of a current encoded picture block, to eliminate spatial redundancy. The picture used for intra prediction may be an I frame.

There are multiple prediction modes for intra prediction. Taking the H series of international digital video coding standards as an example, there are 8 angular prediction modes and 1 non-angular prediction mode for the H.264/AVC standard, and the H.265/HEVC is extended to 33 angular prediction modes and 2 non-angular prediction modes. The intra prediction mode used by HEVC includes a planar mode, a DC mode and 33 angular modes, for a total of 35 prediction modes. The intra modes used by VVC are a Planar mode, a DC mode, and 65 angular modes, for a total of 67 prediction modes.

It should be noted that with the increase of angular modes, intra prediction will be more accurate and more in line with the needs of the development of high-definition and ultra-high-definition digital video.

The residual unit 220 may generate a residual block of a CU based on a sample block of the CU and a prediction block of a PU of the CU. For example, the residual unit 220 may generate a residual block of the CU, so that each sample of the residual block has a value equal to a difference between: a sample of the sample block of the CU and a corresponding sample of the prediction block of the PU of the CU.

The transform/quantization unit 230 may quantize a transform coefficient. The transform/quantization unit 230 may quantize the transform coefficient associated with a TU of a CU based on a quantization parameter (QP) value associated with the CU. The video encoder 200 may adjust a degree of quantization applied to a transform coefficient associated with the CU by adjusting the QP value associated with the CU.

The inverse transform/inverse quantization unit 240 may apply inverse quantization and inverse transform to a quantized transform coefficient, respectively, to reconstruct a residual block from the quantized transform coefficient.

The reconstruction unit 250 may add a sample of the reconstruction residual block to a corresponding sample of one or more prediction blocks generated by the prediction unit 210, to generate a reconstructed picture block associated with the TU. By reconstructing the sample block of each TU of the CU in this manner, the video encoder 200 may reconstruct the sample block of the CU.

The in loop filter unit 260 is used to process the inverse-transformed and inverse-quantized samples to compensate for distortion information, and provide a better reference for subsequent encoded samples. For example, a deblocking filtering operation may be performed to reduce block artifacts of the sample block associated with the CU.

In some embodiments, the in loop filter unit 260 includes a deblocking filter unit and a sample adaptive offset/adaptive loop filter (SAO/ALF) unit, where the deblocking filter unit is used to remove block artifacts, and the SAO/ALF unit is used to remove a ringing effect.

The decoded picture buffer 270 may store the reconstructed sample block. The inter prediction unit 211 may use a reference picture containing the reconstructed sample block to perform the inter prediction on a PU of another picture. In addition, the intra estimation unit 212 may use the reconstructed sample block in the decoded picture buffer 270 to perform intra prediction on other PUs in the same picture as the CU.

The entropy coding unit 280 may receive the quantized transform coefficient from the transform/quantization unit 230. The entropy coding unit 280 may perform one or more entropy encoding operations on the quantized transform coefficient, to generate entropy-encoded data.

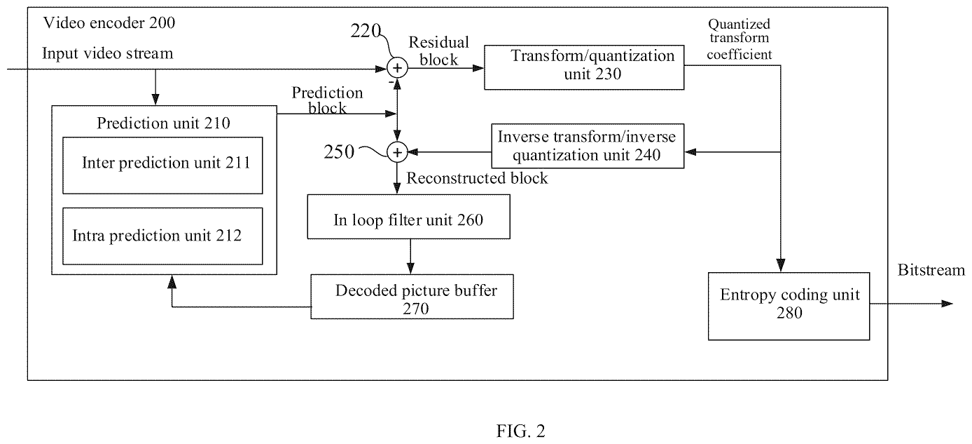

FIG. 3 is a schematic block diagram of a video decoder involved in the embodiments of the present disclosure.

As illustrated in FIG. 3, the video decoder 300 contains: an entropy decoding unit 310, a prediction unit 320, an inverse quantization/inverse transform unit 330, a reconstruction unit 340, an in loop filter unit 350, and a decoded picture buffer 360. It should be noted that the video decoder 300 may contain more, fewer or different functional components.

The video decoder 300 may receive a bitstream. The entropy decoding unit 310 may parse the bitstream to extract a syntax element from the bitstream. As a part of parsing the bitstream, the entropy decoding unit 310 may parse the entropy-coded syntax element in the bitstream. The prediction unit 320, the inverse quantization/inverse transform unit 330, the reconstruction unit 340, and the in loop filter unit 350 may decode video data according to the syntax element extracted from the bitstream, that is, to generate decoded video data.

In some embodiments, the prediction unit 320 includes an intra estimation unit 322 and an inter prediction unit 321.

The intra estimation unit 322 may perform the intra prediction to generate a prediction block of a PU. The intra estimation unit 322 may use an intra prediction mode to generate a prediction block of a PU based on a sample block of a spatial neighboring PU. The intra estimation unit 322 may also determine the intra prediction mode of the PU according to one or more syntax elements parsed from the bitstream.

The inter prediction unit 321 may construct a first reference picture list (list 0) and a second reference picture list (list 1) according to the syntax element parsed from the bitstream. In addition, if the PU is encoded by using the inter prediction, the entropy decoding unit 310 may parse motion information of the PU. The inter prediction unit 321 may determine one or more reference blocks of the PU according to motion information of the PU. The inter prediction unit 321 may generate a prediction block of the PU according to one or more reference blocks of the PU.

The inverse quantization/inverse transform unit 330 may inverse quantize (i.e., dequantize) a transform coefficient associated with a TU. The inverse quantization/inverse transform unit 330 may use a QP value associated with the CU of the TU to determine a degree of the quantization.

After inverse-quantizing the transform coefficient, the inverse quantization/inverse transform unit 330 may apply one or more inverse transforms to the inverse-quantized transform coefficient, to generate a residual block associated with the TU.

The reconstruction unit 340 uses the residual block associated with the TU of the CU and the prediction block of the PU of the CU to reconstruct a sample block of the CU. For example, the reconstruction unit 340 may add a sample of the residual block to a corresponding sample of the prediction block to reconstruct the sample block of the CU, to obtain a reconstructed picture block.

The in loop filter unit 350 may perform a deblocking filtering operation to reduce block artifacts of the sample block associated with the CU.

The video decoder 300 may store the reconstructed picture of the CU in the decoded picture buffer 360. The video decoder 300 may use the reconstructed picture of the decoded picture buffer 360 as a reference picture for subsequent prediction, or transmit the reconstructed picture to a display apparatus for presentation.

A basic procedure of video encoding and decoding is as follows: at an encoder side, a frame picture is partitioned into blocks, and for a current block, the prediction unit 210 generates a prediction block of the current block by using intra prediction or inter prediction. The residual unit 220 may calculate a residual block based on the prediction block and an original block of the current block, that is, a difference between the prediction block and the original block of the current block. The residual block may also be referred to as residual information. The residual block is transformed and quantized by the transform/quantization unit 230 and processed in other ways, so that information to which human's eyes are not sensitive may be removed, thereby eliminating visual redundancy. Optionally, the residual block before transform and quantization performed by the transform/quantization unit 230 may be referred to as a time domain residual block, and the time domain residual block transformed and quantized by the transform/quantization unit 230 may be referred to as a frequency residual block or a frequency domain residual block. The entropy encoding unit 280 receives a quantized transform coefficient output by the transform/quantization unit 230, and may perform entropy-coding on the quantized transform coefficient, to output a bitstream. For example, the entropy encoding unit 280 may eliminate character redundancy according to a target context model and probability information of a binary bitstream.

At a decoder side, the entropy decoding unit 310 may parse the bitstream to obtain prediction information, a quantization coefficient matrix, etc., of the current block, and the prediction unit 320 generates a prediction block of the current block by using intra prediction or inter prediction for the current block, based on the prediction information. The inverse quantization/inverse transform unit 330 uses the quantization coefficient matrix obtained from the bitstream to perform inverse quantization and inverse transform on the quantization coefficient matrix to obtain a residual block. The reconstruction unit 340 adds the prediction block and the residual block, to obtain a reconstructed block. The reconstructed block constitutes a reconstructed picture. The in loop filter unit 350 performs in loop filtering on the reconstructed picture based on a picture or a block, to obtain a decoded picture. The encoder side also needs to perform operations similar to those of the decoder side, to obtain a decoded picture. The decoded picture may also be referred to as a reconstructed picture, and the reconstructed picture may be used as a reference picture of the inter prediction for a subsequent frame.

It should be noted that block partition information, as well as mode information such as prediction, transform, quantization, entropy encoding, in loop filtering, etc., or parameter information, etc., determined by the encoder side, are carried in the bitstream when necessary. The decoder side determines the same block partition information, mode information such as prediction, transform, quantization, entropy encoding, in loop filtering, etc., or parameter information as the encoder side, by parsing the bitstream and performing analysis according to existing information, thereby ensuring that the decoded picture obtained by the encoder side is the same as the decoded picture obtained by the decoder side.

The above is the basic procedure of a video codec under the block-based hybrid coding framework, and with the development of the technology, some modules or steps of this framework or procedure may be optimized, and the present disclosure is applicable to the basic procedure of the video codec under the block-based hybrid coding framework, but is not limited to this framework and procedure.

In some embodiments, the current block may be a current coding unit (CU) or a current prediction unit (PU), etc. Due to the need for parallel processing, a picture may be partitioned into slices, etc., and slices in a same picture may be processed in parallel, that is, there is no data dependency between the slices. The “frame” is a commonly used term, which may generally be understood as one frame being one picture. In the present disclosure, the frame may also be replaced by a picture or a slice, etc.

It can be seen from the above that temporal correlation are used for the inter prediction to eliminate the redundancy. In order to prevent human eyes from perceiving stuttering, the frame rate of a general video will be 30 frames per second, 50 frames per second, 60 frames per second, or even 120 frames per second. In this video, the correlation between adjacent frames in the same scene is very high. This correlation is used in the inter prediction technology, to refer to the content of the coded frame to predict the content to be coded currently. Inter prediction may greatly improve the coding performance.

The most basic inter prediction method is translational prediction, and it is assumed in the translational prediction that the content to be predicted currently translationally moves between the current picture and the reference picture, and for example, the content of the current block (coding unit or prediction unit) is translated between the current picture and the reference picture, then this content may be found in the reference picture through a motion vector (MV) and used as a prediction block of the current block. Translational motion occupies a large proportion in the video, and the still background, overall translational object(s), and camera translation, etc., may all be processed by using the translational prediction.

Some contents in the natural video are not simply translational. For example, there are some subtle changes in the translation process, including changes in shape, color, etc. Two reference blocks are found from the reference picture by bi-directional prediction, and weighted averaging is performed on the two reference blocks, to obtain a predicted block that is as similar as possible to the current block. For example, for some scenes, performing weighted averaging on a reference block found from the front and the back of the current picture respectively, may be more similar to the current block than that on a single reference block. Based on this, the bi-directional prediction further improves compression performance on the basis of unidirectional prediction.

Picture order count (POC) may be used as a flag of the picture, and in a segment of video sequences, each picture has a unique POC. In the embodiments of the present disclosure, it is considered that the order of POC is the same as the playback order. A P picture (P Frame) is a picture that may be predicted only by using reference picture(s) with POC before the current picture. The current reference picture has only a reference picture list, denoted as RPL0. Herein, the RPL may be understood as the abbreviation of Reference Picture List. In the reference picture list RPL0, there are all reference pictures with POCs before the current picture. Previously, a B picture (B Frame) was a picture that may be predicted by using reference picture(s) with POC before the current picture and reference picture(s) with POC after the current picture. The B picture has two reference picture lists, denoted as RPL0 and RPL1. A configuration method is that there are all reference pictures with POCs before the current picture in the RPL0, and there are all reference pictures with POCs after the current picture in the RPL1. For a current block, reference may be only made to a reference block of a certain picture in RPL0, which is also referred to as forward prediction; or reference may be only made to a reference block of a certain picture in RPL1, which is also referred to as backward prediction; or references may be made to both a reference block of a certain picture in RPL0 and a reference block of a certain picture in RPL1 simultaneously, which is also referred to as bi-directional prediction. A simple method of referring to two reference blocks simultaneously is to average samples at each corresponding position of the two reference blocks to obtain the prediction block of the current block. Later, for the B picture, it is no longer limited to that there are all reference pictures with POCs before the current picture in the RPL0, and to that there are all reference pictures with POCs after the current picture in the RPL1. Therefore, the RPL0 may also have a reference picture with a POC after the current picture, and the RPL1 may also have a reference picture with a POC before the current picture. The current block may also simultaneously refer to a reference picture with a POC before the current picture or simultaneously refer to a reference picture with a POC after the current picture. This B picture is also referred to as a generalized B picture.

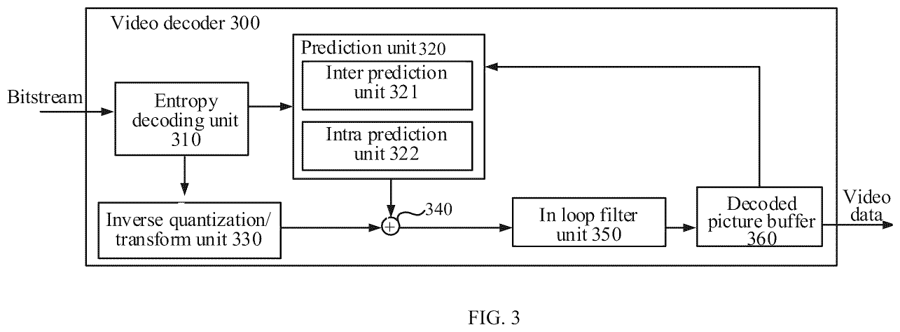

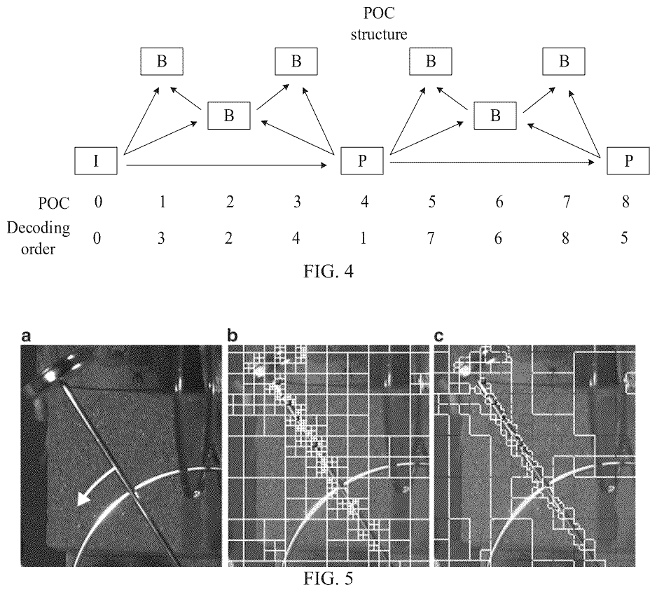

The coding order of a Random Access (RA) configuration is different from the order of the POC. In this way, the B picture may refer to information before the current picture and information after the current picture, thereby significantly improving the coding performance. A classic GOP structure of the RA is illustrated in FIG. 4, where the arrows indicate reference relationships. An I picture does not require a reference picture, and after the I picture with a POC of 0 is decoded, a P picture with a POC of 4 is decoded, and when decoding the P picture with the POC of 4, reference may be made to the I picture with the POC of 0. Then, a B picture with a POC of 2 is decoded, and when decoding the B picture with the POC of 2, reference may be made to the I picture with the POC of 0 and the P picture with the POC of 4, and so on.

The coding order of a Low Delay (LD) configuration is the same as the order of the POC. Therefore, the current picture may only refer to information before the current picture. The Low Delay configuration is also divided into Low Delay P (LDP configuration) and Low Delay B (LDB configuration). The Low Delay P is the traditional Low Delay configuration. Its typical structure is IPPP . . . , that is, an I picture is coded first, and subsequent pictures are all P frames. The typical structure of the Low Delay B is IBBB . . . , the difference from the Low Delay P is that each inter picture is a B picture, that is, two reference picture lists are used, and the current block may simultaneously refer to a reference block of a certain picture in the RPL0 and a reference block of a certain picture in the RPL1.

Generally, the compression efficiency of the RA configuration is higher than that of the LD configuration, and the compression efficiency of the LDB configuration is higher than that of the LDP configuration. On the one hand, because bi-directional prediction may refer to backward information, and on the other hand, because bi-directional prediction may reduce prediction errors through some technologies, such as weighted averaging, etc.

A reference picture list of the current picture may have several reference pictures at most, such as 2, 3 or 4. When a certain current picture is encoded, which reference pictures are in the RPL0 and the RPL1 respectively, is determined by a certain configuration or algorithm, which is not the focus of the present disclosure. However, the same reference picture may simultaneously be present in both RPL0 and RPL1. That is, the codec allows the current block to refer to two reference blocks of the same reference picture simultaneously.

The codec usually uses an index in the reference picture list to find a corresponding reference picture. If a length of a reference picture list is 4, indexes have four values: 0, 1, 2, and 3. For example, the RPL0 of the current picture has four reference pictures with POCs of 5, 4, 3, and 0. Then, index 0 of RPL0 is a reference picture of POC 5, index 1 of RPL0 is a reference picture of POC 4, index 2 of RPL0 is a reference picture of POC 3, and index 3 of RPL0 is a reference picture of POC 0.

The inter prediction uses motion information to represent “motion”. Basic motion information contains information of a reference picture and information of a motion vector (MV). To use bi-directional prediction, a block naturally needs to find two reference blocks, and then needs two groups of information of the reference picture and information of the motion vector. Each of these groups may be understood as a piece of unidirectional motion information, and combining these two groups together forms a piece of bi-directional motion information. In a specific implementation, the unidirectional motion information and the bi-directional motion information may use a same data structure, in which the two groups of information of the reference picture and information of the motion vector of the bi-directional motion information are both valid, while one group of information of the reference picture and information of the motion vector of the unidirectional motion information is invalid. The “valid” may also be referred to as “use”, and the “invalid” may also be referred to as “not use”.

VVC supports 2 reference picture lists, denoted as RPL0 and RPL1, and for the above-mentioned bi-directional motion information, VVC uses a reference picture index (refldxL0) corresponding to the RPL0, and a motion vector (mvL0) corresponding to the RPL0, a reference picture index (refIdxL1) corresponding to the RPL1, and a motion vector (mvL1) corresponding to the RPL1. Here, the reference picture index corresponding to the RPL0 and the reference picture index corresponding to the RPL1 may be understood as the information of the reference pictures mentioned above. VVC uses two flags to represent whether to use the motion information corresponding to the RPL0 and whether to use the motion information corresponding to the RPL1 respectively, which are denoted as predFlagL0 and predFlagL1, respectively. It may also be understood that the predFlagL0 and predFlagL1 represent whether the above-mentioned unidirectional motion information is “valid”. Therefore, although VVC does not explicitly mention this data structure of the motion information, it uses the reference picture index, the motion vector and the flag bit of whether to be “valid” corresponding to each reference picture list to represent the motion information. In the standard text of the VVC, the motion information does not appear, but the motion vector is used, and the reference picture index and the flag of whether to use the corresponding motion information may also be considered as subsidiary to the motion vector. Herein, the “motion information” is still used for the convenience of description, but it should be understood that it may also be described as the “motion vector”. “Motion information” may also be referred to as a “motion parameter”.

For a two-dimensional picture, the motion vector may be represented by (x, y), i.e., a component in the horizontal direction and a component in the vertical direction. Since videos are represented by samples, there is a distance between samples, and the movement of an object between adjacent pictures may not always correspond to an integer sample distance. For example, in a distant view video, the distance between two samples on a distant view object is 1 meter, while the distance that this object moves within the time between two frames is 0.5 meters, so that this scene cannot be well represented by the motion vector of the integer sample. Therefore, the motion vector may be represented at a sub-sample level, such as ½ sample precision, ¼ sample precision, ⅛ sample precision, and 1/16 sample precision, to represent the motion more finely. And a sample value of a sub-sample position in the reference picture is obtained by an interpolation method.

The unidirectional prediction and bi-directional prediction in the above-mentioned translational prediction are both based on blocks, such as coding units or prediction units. That is, a sample matrix is taken as a unit for prediction. The most basic block is a rectangular block, such as a square and a rectangle. Video coding standards such as HEVC and VVC allow the encoder to determine a size and a partition mode of the coding unit and the prediction unit according to the content of the video. A larger block tends to be used for a region with simple texture or motion, while a smaller block tends to be used for a region with complex texture or motion. The deeper the level of the block partition, the more complex blocks that are more similar to the actual texture or motion can be partitioned, but accordingly, the overhead used to represent these partitions will be greater. The motion information may also need to be transmitted in the bitstream. And in general, the finer the block partition, the greater the overhead of the motion information.

The most original method for representing motion information is to directly write the complete motion information. Later, experts discovered that the motion vector may be represented by a motion vector prediction (MVP) plus a motion vector difference (MVD), that is, MV=MVP+MVD. The more accurate the MVP is, the smaller the MVD is, which results in lower overhead occupied in the bitstream.

It can be understood that, each inter-coded block needs a piece of motion information. To simplify the issue, it is assumed that the partition of CU is equal to the partition of PU and equal to the partition of TU, that is, a coding unit has a prediction unit with the same size and same position and a transform unit with the same size and same position. Actually, as CU partition becomes more flexible, VVC tends to weaken PU and TU, compared to HEVC. A difference in a certain stage in prediction, transform, quantization, or entropy coding may lead to CU partition. For example, if the motion information of two region is different, the encoder may partition the two regions into different CUs. For another example, if the motion information of two regions is the same or similar, but the residual characteristics are very different, the encoder may also partition these two regions into different CUs. How to partition is determined by the overall compression efficiency and does not depend entirely on a certain factor. Therefore, a same object or regions with the same or similar motion are partitioned into different CUs.

Exemplarily, as illustrated in FIG. 5, FIG. 5 is an example of HEVC, where a is an original picture, in which an iron rod moves in the direction indicated by the arrow, and the background region moves less. Picture b shows the block partition of HEVC, and boundaries of blocks with the same motion information in picture b are removed in picture c. It can be seen that many adjacent blocks use the same motion information. In this case, separately encoding motion information for each block would result in an obvious waste. The complete motion information of VVC mentioned above includes the reference picture index of RPL0, the flag of whether MV is used, the reference picture index of RPL1, and the flag of whether MV is used. A basic principle of a merge mode is that the current block may inherit the motion information of adjacent blocks, including the information of the reference picture and the information of the motion vector.

The Merge mode may construct a merge candidate list, and if the current block uses the Merge mode, an index may be used to indicate which motion information the current block merges with, thus it does not need to encode the complete motion information. When constructing the merge candidate list, motion information of adjacent blocks in the spatial domain, motion information in the temporal domain, motion information of non-adjacent blocks in the spatial domain, motion information non-adjacent blocks in the temporal domain, history-based motion information, synthesized motion information, etc., of the current block may be added.

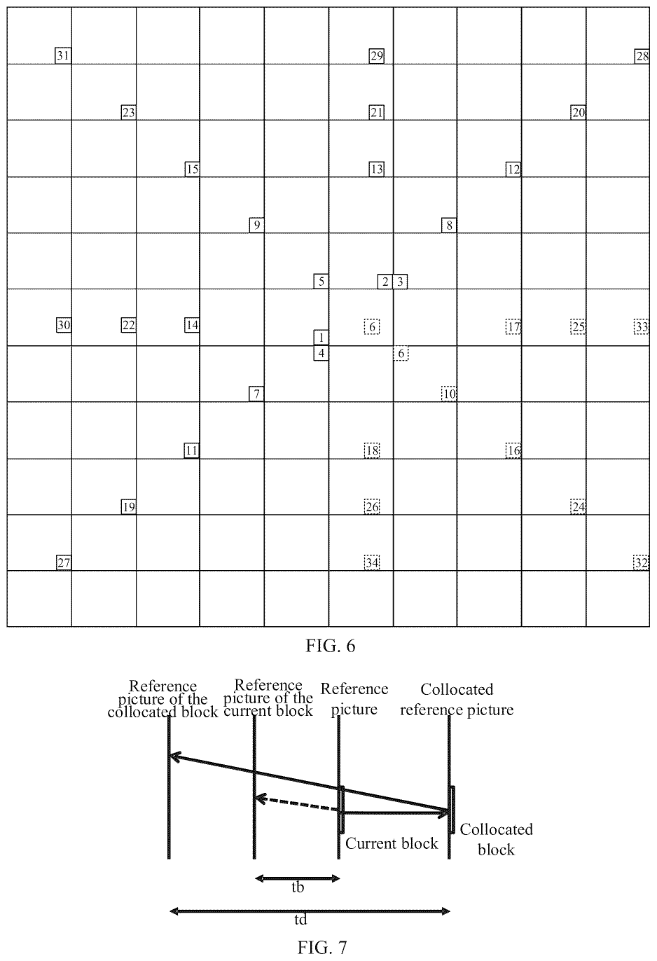

The adjacent blocks in the spatial domain refer to blocks adjacent to the current block in the same picture, and the non-adjacent blocks in the spatial domain refer to blocks non-adjacent to the current block in the same picture. The motion information in the temporal domain and the motion information of non-adjacent blocks in the temporal domain refer to motion information of specified positions in a collocated reference picture. Exemplarily, as illustrated in FIG. 6, a large block filled with diagonal lines is the current block, positions 1, 2, 3, 4, and 5 are positions of adjacent blocks in the spatial domain used in the Merge, and other positions surrounded by solid lines are positions of non-adjacent blocks in the spatial domain used in the Merge. Position 6 is a position used for the motion information in the temporal domain, and if the position corresponding to the lower-right corner of the current block is not available, a position corresponding to the center of the current block is used. The other positions surrounded by dashed lines are positions used by the motion information of non-adjacent blocks in the temporal domain. Temporal motion information is derived according to the motion information at the corresponding position of the collocated reference picture.

The temporal motion information prediction is used as a supplement to the spatial motion information prediction. In general, the correlation between adjacent regions in a same picture is stronger than the correlation in different pictures. But there are some cases where temporal motion information is better. To give a simple example, for example, the current block and the surrounding adjacent blocks in the current picture belong to different objects and have completely different motions, however, the motion of the block that belongs to a same object as the current block, in a certain reference picture may provide better motion information prediction for the current block.

Exemplarily, as illustrated in FIG. 7, a motion vector of a collocated block (here, a block for acquiring temporal motion information is referred to as the collocated block) on the collocated reference picture is a vector from the collocated reference picture col_pic to a reference picture col_ref of the collocated block. For the current block, its required motion vector is a vector from the current picture curr_pic to the reference picture curr_ref of the current block. Set a POC distance between the col_pic and the col_ref to be td, and a POC distance between the curr_pic and the curr_ref to be tb. Assuming that the motion from the collocated block to the current block is unchanged, a scaling ratio may be determined according to the td and the tb. Assuming that the motion vector of the collocated block is (col_mv_x, col_mv_y), then the temporal motion vector prediction (tmvp_x, tmvp_y) may be derived according to Formula (1) as follows:

$$tmvp\_x = col\_mv \_x * tb / td , tmvp\_y = col\_mv \_y * tb / td \qquad ( 1 )$$

In VVC, a minimum unit for storing motion information on the collocated reference picture is 4×4. That is, each 4×4 subblock stores a group of motion information. It can be understood that, if the cost of hardware implementations is not considered, the collocated reference picture can also store a group of motion information for each sample.

In VVC, a subblock-based temporal motion vector prediction is introduced, that is, Subblock-based temporal motion vector prediction (SbTMVP). In general, motion vector prediction (MVP) and temporal motion vector prediction (TMVP) are both considered for the whole block, that is, the whole block shares a same MVP. However, the SbTMVP is based on subblocks, so that for the SbTMVP, an MVP may be obtained for each sub-block. This is also the essential difference between the SbTMVP and the TMVP.

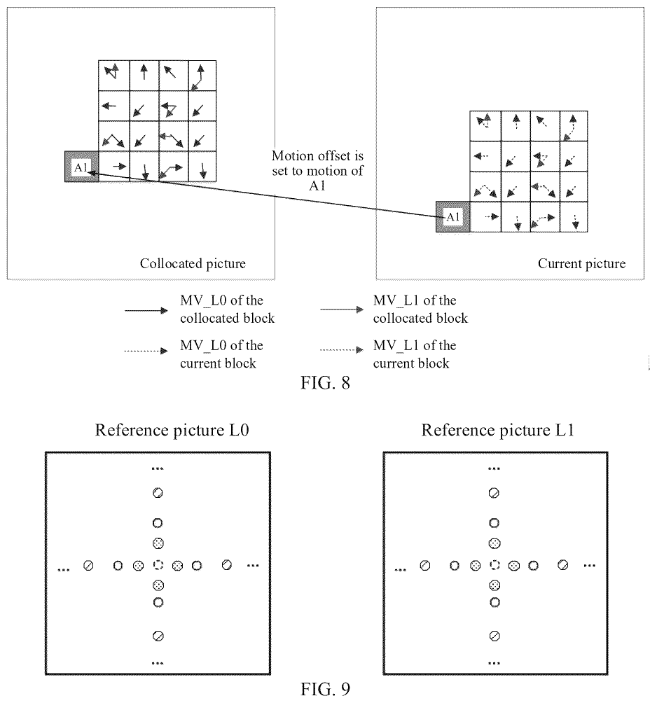

On the other hand, the TMVP uses the position of the lower-right corner of the current block or the position of the center of the current block to locate the collocated block, while the SbTMVP finds a motion offset according to the motion of surrounding blocks to determine the position. In the VVC, if the block at position A1 refers to the collocated reference picture, the motion offset is set to the motion vector of A1 using the collocated reference picture. Otherwise, the motion offset is set to (0, 0). As illustrated in FIG. 8, the position is found according to the motion offset, and then the MV corresponding to the position of each sub-block in the “collocated block” is scaled to obtain the MVP of each sub-block. In the Merge mode, the motion information in the merge candidate list is directly selected as the motion information of the current block. In the actual video, sometimes, there may be some differences between an actual motion vector of the current block and the selected motion vector in the merge candidate list. Merge mode with MVD (MMVD for short) is a special Merge mode in VVC, which encodes the MVD in this case by using an efficient method. The normal Merge does not need to code the motion vector difference (MVD). The normal inter mode needs to directly code the MVD. As illustrated in FIG. 9, the characteristic that the MVD is more distributed in a single horizontal direction or a single vertical direction, i.e., the characteristic that the smaller value the more MVDs and the larger value the less MVDs, is used in the MMVD.

As illustrated in FIG. 9, MMVD can only represent MVDs with specific values in some specific directions, and it cannot represent arbitrary MVDs. It uses mmvd_direction_idx to represent the direction of the MVD, and of course, it may also be understood as whether x and y of the MVD are non-zero, and their positive and negative signs, and it uses mmvd_distance_idx to represent an absolute value MmvdDistance of the non-zero one of x and y of the MVD.

Exemplarily, the relationship between mmvd_distance_idx[x0][y0] and MmvdDistance[x0][y0] is shown in Table 1:

TABLE 1

| | MmvdDistance[x0][y0] | |
|---|---|---|
| mmvd_distance_{—} | ph_mmvd_fullpel_{—} | ph_mmvd_fullpel_{—} |
| idx[x0][y0] | only_flag == 0 | only_flag == 1 |
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

Herein, ph_mmvd_fullpel_only_flag is a picture header flag, and 2 different combinations of MMVD may be set.

Exemplarily, the relationship MmvdSign[x0][y0] is shown in Table 2:

TABLE 2

| mmvd_direction_{—} | | |
|---|---|---|
| idx[x0][y0] | MmvdSign[x0][y0][0] | MmvdSign[x0][y0][1] |
| 0 | +1 | 0 |
| 1 | −1 | 0 |
| 2 | 0 | +1 |
| 3 | 0 | −1 |

In some embodiments, the MVD of MMVD is obtained according to Formula (2) as follows:

$$MmvdOffset [ x 0 ] [ y 0 ] [ 0 ] = ( MmvdDistance [ x 0 ] [ y 0 ] ≪ 2 ) * MmvdSign [ x 0 ] [ y 0 ] [ 0 ] \qquad ( 2 )$$

$$MmvdOffset [ x 0 ] [ y 0 ] [ 1 ] = ( MmvdDistance [ x 0 ] [ y 0 ] ≪ 2 ) * MmvdSign [ x 0 ] [ y 0 ] [ 1 ]$$

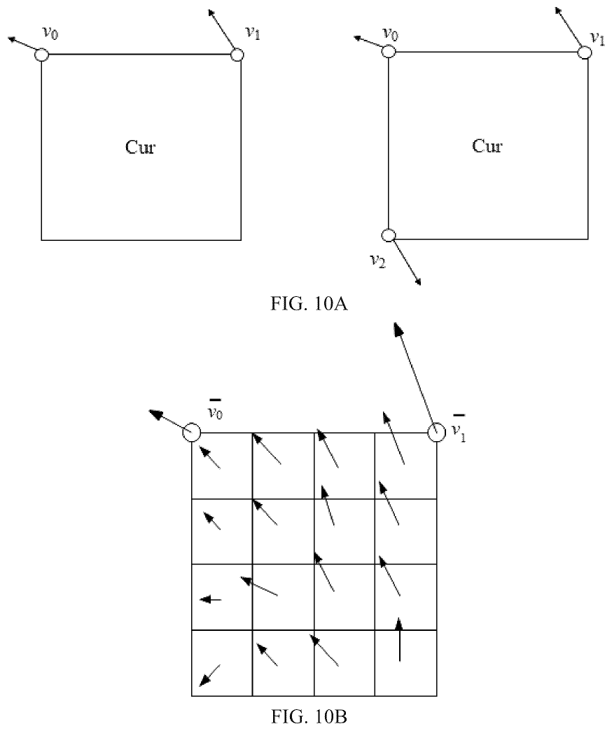

The simplest and most commonly used translational motion is introduced above, and in the real world, motion isn't limited to translation, but also includes many forms, such as zooming in, zooming out, rotation, perspective of motion (perspective: objects closer to the camera appear larger, while objects farther away the camera appear smaller), and many irregular forms of motion. Affine may be used to represent more complex motion than the translation. As illustrated in FIG. 10A, Affine uses a linear model to calculate the motion vector of each sub-block or each sample in the current block, according to motion vectors of 2 control points (4 parameters, a motion vector includes two parameters x and y) or motion vectors of 3 control points (6 parameters).

In an example, for a 4-parameter Affine model, the motion vector at the (x, y) position in the current block is derived according to Formula (3) as follows:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 3 )$$

In an example, for a 6-parameter Affine model, the motion vector at the (x, y) position in the current block is derived according to Formula (4) as follows:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 4 )$$

Herein, (mv₀ₓ, mv_{0y}) is the motion vector of the control point in the upper-left corner of the current block, (mv₁ₓ, mv_{1y}) is the motion vector of the control point in the upper-right corner of the current block, and (mv₂ₓ, mv_{2y}) is the motion vector of the control point in the lower-left corner of the current block.

In order to simplify the complexity of hardware implementations, Affine used in VVC partitions the current block into 4×4 sub-blocks, calculates an MV for each sub-block and performs motion compensation. Exemplarily, FIG. 10B is an example of Affine deriving a motion vector based on a sub-block. It can be understood that with the enhancement of hardware processing capabilities, Affine may also perform the sample-based processing. That is, a motion vector is derived for each sample, and motion compensation is performed on a sample according to the motion vector.

Affine only needs several control points to derive the respective motion vector for each sub-block or each sample, and compared with whole-block-based motion compensation, it may achieve the finer prediction. With respect to smaller partitioned CUs, Affine has much less overhead.

In some embodiments, HEVC supports a maximum CTU of 64×64 and may recursively perform quadtree partitioning. VVC supports a more flexible block partitioning method than HEVC, which supports a maximum CTU of 128×128, including quadtree partition, ternary tree partition and binary tree partition. For these partition methods, although block partition is becoming more and more flexible, whether it is CU, PU, or TU, it may only be partitioned into rectangular blocks. It should be noted that, VVC has weakened the partition of PU and TU. The boundaries of textures or motion in the natural video are diverse. For example, for an oblique object boundary, solely using rectangular blocks to approximate the boundaries would need to partition into many small blocks, which will significantly increase the overhead. The geometric partitioning prediction prediction mode (GeometricpartitioningMode, GPM) may better handle the textures and boundaries in the natural video.

Two prediction blocks with the same size as the current block are used in GPM, in the prediction block of the GPM, some sample positions 100% use a sample value of a corresponding position of a first prediction block, and some sample positions 100% use a sample value of a corresponding position of a second prediction block, while in a boundary region or blending region, sample values of the corresponding positions of the two prediction blocks are used in a certain proportion. The weights of the boundary regions are also blended gradually. Of course, for scenarios such as screen content encoding, the blending region may not be used. How these weights are distributed is determined by the “partitioning” mode of the GPM. The weight of each sample position is determined according to the “partitioning” mode of the GPM. Of course, in some cases, such as in a case where the block size is very small, it may not be guaranteed in some modes of the GPM that there must be some sample positions 100% using the sample value of the corresponding position of the first prediction block and some sample positions 100% using the sample value of the corresponding position of the second prediction block. It may also be considered that two prediction blocks with different sizes from the current block are used in the GPM, that is, each takes a required portion. Portions with a weight of 0 are eliminated. This is an implementation issue and is not the focus of the present disclosure.

Exemplarily, FIG. 11 is a weight diagram of 64 modes of GPM in VVC on a square block. The black represents that the weight value of the corresponding position of the first prediction block is 0%, the white represents that the weight value of the corresponding position of the first prediction block is 100%, and the gray region represents that the weight value of the corresponding position of the first prediction block is a certain weight value greater than 0% and less than 100% according to different shades of the color. The weight value of the corresponding position of the second reference block is 100% minus the weight value of the corresponding position of the first reference block.

GPM may be said to be a prediction mode or a prediction method, because it finally generates a prediction block. It may also be said that GPM is a “partitioning” mode, which partitions the prediction block in a simulated manner, which is similar to the implementation of PU partition, but is not the actual partition. The first prediction block and the second prediction block used in the above GPM may be prediction blocks generated by intra prediction, may be prediction blocks generated by inter unidirectional prediction, or may be prediction blocks generated by inter bi-directional prediction.

In some embodiments, a bit rate of general consumer-type videos is limited, so video compression usually seeks a trade-off between bitstream overhead and distortion. Taking block partition as an example, for the same content, within a certain range, the finer the partition, the greater the overhead and the smaller the distortion; the rougher the partition, the less the overhead and the greater the distortion. Taking the encoding of motion information as an example, for the same content, within a certain range, the more accurate the motion information, the greater the overhead and the smaller the distortion; the rougher the motion information, the less the overhead and the greater the distortion. Some methods on the decoder side use information on the decoder side for processing and calculation without occupying the overhead, thereby achieving the effects of refining the motion information, refining prediction effects, and reducing distortion. Not occupying the overhead also means that there are no indications performed by the encoder according to the original picture, the decoder side processes automatically according to available information. Two typical methods on the decoder side in VVC are DMVR (Decoder side motion vector refinement) and BDOF (bi-directional optical flow).

A condition for starting DMVR in VVC is that two reference pictures of the current block come from the front and the back of the current picture, respectively, and distances between the two reference pictures and the current picture are equal. Another starting condition is that the current CU uses the whole-block-based merge mode (including skip), and the whole-block-based merge mode does not contain the sub-block-based merge such as SbTMVP and affine merge, because the motion vector in the merge mode is prone to being not precise enough. There are some other conditions, which will not be repeated herein. DMVR in VVC uses bilateral matching (BM), which is to calculate matching costs for reference blocks on two sides, such as an SAD (sum of absolute difference). DMVR searches for the matching costs of MVs surrounding the original MV, and when moving, the MVs of the two reference pictures are moved in a mirrored manner, that is, a side moves by MVdiff and another side moves by −MVdiff on the basis of the respective original MV, as illustrated in FIG. 12. The search also supports sub-sample-based search, so DMVR may find an MV with higher precision than the original MV. The search is performed according to a certain rule, and generally, integer sample MVs within a certain range are searched first to find the integer sample MV with a minimum matching cost, and then the sub-sample MVs are searched on the basis of the integer sample MV. If an MV with a smaller matching cost than the original MV is found, the MV with the smaller matching cost is used for motion compensation prediction. In theory, after the MV is refined by DMVR, the MV may be used to be stored and used for surrounding blocks, for example, when a merge candidate list is constructed for the current block, if the MV is refined by using DMVR for the surrounding blocks, using the refined MV to construct the merge candidate list may achieve a better compression effect, however, due to the consideration of hardware implementations, VVC does not do this.

DMVR may be processed based on sub-blocks. Actually, in VVC, if the horizontal direction or vertical direction size of a block is larger than 16 samples, the block will be partitioned into sub-blocks with the size of 16 samples. On one hand, this is based on the consideration of the hardware implementation complexity, because DMVR requires searching at the decoder side, and limiting the size of sub-blocks may reduce the cost of the buffer. On the other hand, partitioning into sub-blocks for processing provides better flexibility, and each sub-block may refine the MV independently, which achieves the effect of improving the partition accuracy to a certain extent, and also improves the compression efficiency.

Bi-directional optical flow (BDOF for short) is also a typical decoder side method. BDOF refines the MV and prediction based on the optical flow principle. The optical flow is an instantaneous speed of sample movement of a spatially moving object on an observation picturing plane. The optical flow has some basic assumptions, such as constant luma, that is, the luma of the same target does not change when it moves between different pictures. The time continuity or movement is a small movement. That is, changes in time will not cause huge changes in the target position.

A condition for starting BDOF in VVC is that two reference pictures of the current block come from the front and the back of the current picture, respectively, and distances between the two reference pictures and the current picture are equal. For each 4×4 sub-block in VVC, BDOF derives a motion vector deviation (vₓ, v_{y}), this deviation is calculated by minimizing a difference between prediction values in two directions. This motion vector deviation is also used to adjust the prediction value in the corresponding sub-block.

Exemplarily, the process of deriving the prediction value includes as follows.

First, gradients

$$\frac{\partial {I}^{( k )}}{\partial x} ( i , j ) and \frac{\partial {I}^{( k )}}{\partial y} ( i , j )$$

of two prediction blocks in the horizontal direction and the vertical direction are calculated, where k=0, 1.

Exemplarily,

$$\frac{\partial {I}^{( k )}}{\partial x} ( i , j ) and \frac{\partial {I}^{( k )}}{\partial y} ( i , j )$$

are determined by Formula (5) as follows:

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \qquad ( 5 )$$

$$\frac{\partial {I}^{( k )}}{\partial y} ( i , j ) = ( ( {I}^{( k )} ( i , j + 1 ) ) shift 1 ) - ( {I}^{( k )} ( i , j - 1 ) ) shift 1 ) )$$

Herein, I^{(k)}(i, j) is a prediction value of a coordinate (i, j) of the reference picture list k, k=0, 1, shift1 is calculated according to a bit depth bitDepth of the luma, shift1=max(6, bitDepth−6).

Next, the motion vector deviation (vₓ, v_{y}) is calculated.

Exemplarily, (vₓ, v_{y}) is determined by Formula (6) as follows:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \qquad ( 6 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

Herein, S_{2,m}=S₂»n_{S}_{₂}, S_{2,s}=S₂&(2ⁿ^{_{S2}}−1), th′_{BIO}=2^{max(5,BD-7)}. └·┘ means rounding down, and n_{S}_{₂}=12.

Exemplarily, the above S₁, S₂, S₃, S₅, and S₆ are calculated according to Formula (7) as follows:

$${S}_{1} = {\sum }_{( i , j ) ∈ Ω} Abs ( {ψ}_{x} ( i , j ) ) , \qquad ( 7 )$$

$${S}_{2} = {\sum }_{( i , j ) ∈ Ω} {ψ}_{x} ( i , j ) \cdot Sign ( {ψ}_{y} ( i , j ) )$$

$${S}_{3} = {\sum }_{( i , j ) ∈ Ω} θ ( i , j ) \cdot Sign ( {ψ}_{x} ( i , j ) )$$

$${S}_{5} = {\sum }_{( i , j ) ∈ Ω} Abs ( {ψ}_{y} ( i , j ) )$$

$${S}_{6} = {\sum }_{( i , j ) ∈ Ω} θ ( i , j ) \cdot Sign ( {ψ}_{y} ( i , j ) )$$

Herein,

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} , {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} , θ ( i , j ) = ( {I}^{( 1 )} ( i , j ) ≫ {n}_{b} ) - ( {I}^{( 0 )} ( i , j ) ≫ {n}_{b} ) .$$

Ω is a 6×6 window surrounding the 4×4 current sub-block, nₐ is min (1, bitDepth−11), and n_{B} is min(4, bitDepth−8).

Then, each prediction value within the 4×4 sub-block is adjusted according to the motion vector deviation and the gradients.

Exemplarily, an adjustment value of the prediction value is determined by Formula (8) as follows:

$$b ( x , y ) = rnd ( \frac{( {v}_{x} ( \frac{\partial {I}_{( x , y )}^{( 1 )}}{\partial x} - \frac{\partial {I}_{( x , y )}^{( 0 )}}{\partial x} ) + {v}_{y} ( \frac{\partial {I}_{( x , y )}^{( 1 )}}{\partial y} - \frac{\partial {I}_{( x , y )}^{( 0 )}}{\partial y} ) + 1 )}{2} ) \qquad ( 8 )$$

Finally, the prediction value of the current block is adjusted based on the adjustment value of the prediction value above, to obtain the prediction value of BDOF.

Exemplarily, the prediction value of BDOF is determined by Formula (9) as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad ( 9 )$$

Herein, O_{offset} and shift are calculated according to the bit depth of luma. nₐ, n_{b} and shift are all processing to reduce the bit width in the calculation process.

The motion vector deviation of BDOF may achieve very high precision, to enable the prediction to be more accurate, and the subblock-based processing also improves the flexibility, these two aspects are similar to DMVR.

Both DMVR and BDOF have the effect of refining the motion vector. DMVR is based on block matching, and BDOF is based on the optical flow principle. They may be used in combination. An example is as follows, which may be referred to as a multi-pass decoder-side motion vector refinement (MDMVR).

Exemplarily, MDMVR may include: at a first step, refining the motion vector based on whole-block-based bi-directional matching. At a second step, refine the motion vector based on subblock-based bi-directional matching. The size of the sub-block at this step may be 16×16. At a third step, refine the motion vector based on subblock-based bi-directional optical flow. The size of the sub-block at this step may be 8×8. Currently, the steps may be further enriched on this basis, such as a fourth step to refine the motion vector based on 4×4 subblock-based bi-directional optical flow. Alternatively, there may be further refining the motion vector based on point-based bi-directional optical flow.

The method of template matching was used in inter prediction at the earliest, and it uses the correlation between adjacent samples and uses some regions surrounding the current block as a template. When the current block is coded, the left side and the upper side of the current block have already been coded completely according to the coding order. Of course, when it is implemented in an existing hardware decoder, it cannot be necessarily guaranteed that when the current block starts to be decoded, its left side and upper side have been decoded completely, of course, what is said here is an inter block, and for example, in HEVC, when generating a prediction block for the inter coded block, the surrounding reconstructed samples are not required, so the prediction process of the inter block may be performed in parallel. However, an intra coded block must need reconstructed samples on the left side and upper side as reference samples. In theory, the left side and the upper side are available, which means that it may be achieved by making a corresponding adjustment to the hardware design. Relatively speaking, the right side and the lower side are not available in the coding order of the current standard such as VVC.

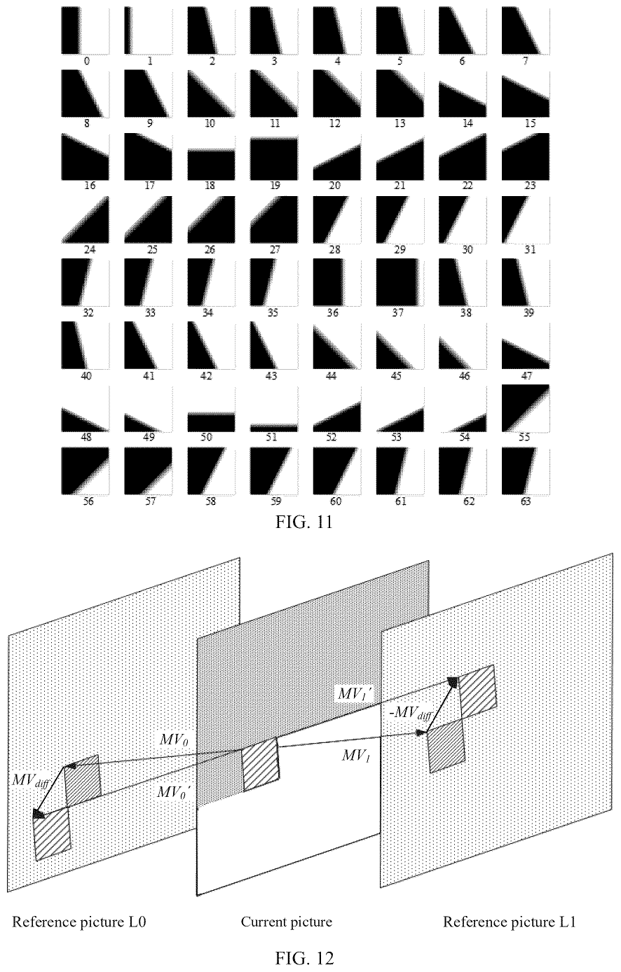

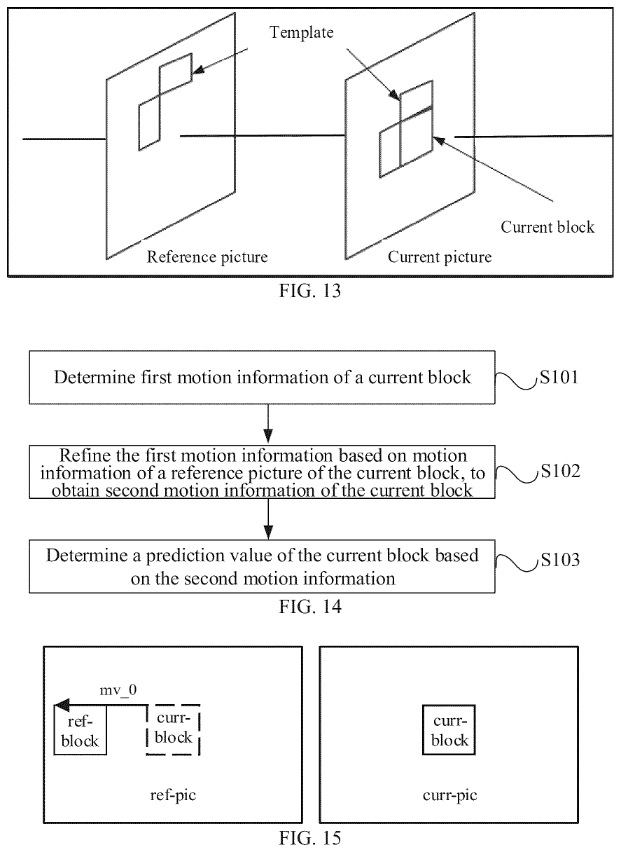

Exemplarily, as illustrated in FIG. 13, rectangular regions on the left side and upper side of the current block are set as templates, and the height of the template portion on the left side is generally the same as the height of the current block, and the width of the template portion on the upper side is generally the same as the width of the current block, but of course, they may also be different. The best matching position of the template is found in the reference picture, to determine the motion information or motion vector of the current block. This process may be roughly described as in a certain reference picture, starting from a starting position, searching within a certain surrounding range. A search rule, such as a search range, a search step size, etc., may be pre-set. Each time when moving to a position, a matching degree between a template corresponding to the position and the template surrounding the current block is calculated, and the said matching degree may be measured by some distortion costs, such as an SAD (sum of absolute difference), an SATD (sum of absolute transformed difference), (generally, the transform used by the SATD is Hadamard transform), and an MSE (mean-square error), etc; the smaller the values of the SAD, the SATD, the MSE, etc., the higher the matching degree. The cost is calculated by using the prediction block of the template corresponding to the position and the reconstructed block of the template surrounding the current block. In addition to searching at the integer sample positions, the search may also be performed at the sub-sample positions, and the motion information of the current block may be determined according to the searched position with the highest matching degree. By using the correlation between adjacent samples, the motion information appropriate for the template may also be the motion information appropriate for the current block. Of course, the method of template matching may not necessarily be applicable to all blocks, so some methods may be used to determine whether the current block uses the above-mentioned method of template matching, for example, a control switch is used for the current block to represent whether to use the method of template matching. A name of this method of template matching is DMVD (decoder side motion vector derivation). Both the encoder and the decoder may use the template for searching, to derive the motion information or find better motion information on the basis of the original motion information. It does not need to transmit a specific motion vector or motion vector difference, and instead, both the encoder and the decoder search according to the same rule, to guarantee the consistency of the encoding and decoding. The method of template matching may improve the compression performance, but it also needs “searching” on the decoder side, thereby bringing some complexity on the decoder side.

As can be known from the above, there are various prediction modes. The encoder may decide which prediction mode or model to be used for the current block, such as: whether to use the merge mode; whether to use the MMVD mode; whether to predict based on a whole block or a sub-block. Where if it is predicted based on the whole block, there are also spatial motion vector prediction and temporal motion vector prediction in the merge candidate list, and if it is predicted based on the sub-block, there are modes such as SbTMVP, Affine, or the like in candidates of the sub-block; or whether to use the GPM mode, etc. On the one hand, the more detailed and accurate the information given to the decoder through the bitstream is, the better prediction the decoder can perform, but the greater the corresponding overhead is. The encoder needs to make a trade-off between the bit rate and distortion. The above modes, such as merge, MMVD, GPM, SbTMVP, Affine or the like provide the decoder with as much information as possible in the more efficient way, and the decoder performs according to the indication of the encoder side. On the other hand, algorithms such as DMVR and BDOF at the decoder side compensate for the distortion caused by the motion vector being not accurate enough, by using methods of block matching or optical flow, which provides the encoder more room to transmit less information to some extent, thereby saving the bitstream overhead. It can be said that the “smarter” the decoder side is, the smaller distortion the decoder side can cause in a case where the encoder side gives the same indication.

In the coding framework constructed by these existing technologies, the decoder obtains an indication of motion information from the bitstream to obtain initial motion information, finds a reference block or a region surrounding the reference block according to the initial motion information, and refines the initial motion information and/or refines the prediction value according to sample value information of the reference block or the region surrounding the reference block. For example, the DMVR searches surrounding the initial MV, and its search process and which MV is finally selected, are depend on the result of block matching; for another example, the BDOF also calculates gradient information, etc., according to sample values, and calculates the instantaneous motion vector difference through the optical flow method.

However, currently, when the decoder side refines the initial motion information determined by decoding, there are problems that the refinement effect is poor, resulting in the prediction value of the current block determined by decoding being not accurate enough, thereby affecting the coding performance of the video.

In order to solve the above technical problem, in the present disclosure, after first motion information of a current block is determined, the first motion information is refined based on motion information of a reference picture of the current block to obtain second motion information, where the motion information of the reference picture is used to refine the first motion information and/or for block partition. That is, in the embodiments of the present disclosure, when refining the first motion information, the motion information of the reference picture is considered, so that the effective refinement of the first motion information is implemented and the accurate second motion information is obtained, and then, when determining a prediction value of the current block based on the accurate second motion information, the prediction accuracy of the current block may be improved, thereby improving the decoding performance of the video.

A video decoding method provided in the embodiments of the present disclosure is introduced below by taking a decoder side as an example, in conjunction with FIG. 14.

FIG. 14 is a schematic flowchart of a video decoding method provided in the embodiments of the present disclosure, and the embodiments of the present disclosure are applied to video decoders illustrated in FIG. 1 and FIG. 3. As illustrated in FIG. 14, the method of the embodiments of the present disclosure includes the following.

In S101, first motion information of a current block is determined.

The decoding method provided in the embodiments of the present disclosure is applied to inter prediction, to refine the motion information of the current block.

As can be seen from the above, due to bitrate considerations, the encoder side carries less prediction-related information in the bitstream, as a result, the motion information of the current block obtained by the decoder side based on the prediction-related information carried in the bitstream, is not accurate enough, and therefore, the decoder side may refine the motion information determined by decoding to improve the prediction effect. However, in the current process of refining the motion information, the motion information of the reference picture is not considered, which results in unsatisfactory refinement of the motion information.

In the embodiments of the present disclosure, when the motion information of the current block is refined, the motion information of the reference picture is considered, so that effective refinement of the motion information of the current block is implemented, thereby improving the prediction accuracy of the current block and improving the decoding performance of the video.

In some embodiments, the first motion information of the current block mentioned above may be understood as initial motion information of the current block, that is, the decoder side obtains the prediction-related information carried by the bitstream by decoding the bitstream, and determines and obtains the motion information based on the prediction-related information. The prediction-related information may include information such as a prediction mode, etc.

In some embodiments, the first motion information of the current block mentioned above may be understood as motion information obtained from the initial motion information of the current block already being refined once or multiple times, and through the method of the embodiments of the present disclosure, the first motion information is further refined based on the motion information of the reference picture.

As can be seen from the above, for inter prediction, motion information is used to represent “motion”. The basic motion information includes information of a reference picture and information of a motion vector (MV). In some embodiments, if a block uses bi-directional prediction, two reference blocks need to be found, so two groups of information of the reference picture and information of the motion vector are required, and each group may be understood as a piece of unidirectional motion information, and these two groups are combined together to form a piece of bi-directional motion information.

In some embodiments, the motion information in the embodiments of the present disclosure may refer to unidirectional motion information, that is, including a group of information of the reference picture and information of the motion vector.

In some embodiments, the motion information in the embodiments of the present disclosure may refer to bi-directional motion information, that is, including 2 groups of information of the reference picture and information of the motion vector.

In some embodiments, the motion information in the embodiments of the present disclosure may refer to multi-directional motion information, that is, including multiple groups of information of the reference picture and information of the motion vector.

In some embodiments, a reference picture index corresponding to each reference picture list, the motion vector, and the flag of whether to be “valid” may be used together to represent the motion information.

The embodiments of the present disclosure do not limit the specific manner for the decoder side to determine the first motion information of the current block.

In a possible implementation, the encoder side carries a prediction mode of the current block in the bitstream. In this way, the decoder side obtains the prediction mode of the current block by decoding the bitstream, and then determines the first motion information of the current block based on the prediction mode.

For example, the decoder side obtains initial motion information of the current block based on the prediction mode, and determines the initial motion information as the first motion information.

For another example, the decoder side obtains initial motion information of the current block based on the prediction mode, and then refines the initial motion information, and determines the refined initial motion information as the first motion information. Exemplarily, the method for the decoder side to refine the initial motion information may be to use the above-mentioned DMVR and/or BDOF modes for the refinement. For example, the decoder side uses the refinement method of the DMVR to refine the initial motion information of the current block to obtain the first motion information. For another example, the decoder side uses the refinement method of the BDOF to refine the initial motion information of the current block to obtain the first motion information. For another example, the decoder side first uses the refinement method of the DMVR to refine the initial motion information, and then uses the refinement method of the BDOF for further refinement, to obtain the first motion information. For another example, the decoder side first uses the refinement method of the BDOF to refine the initial motion information, and then uses the refinement method of the DMVR for further refinement, to obtain the first motion information. For the specific refinement methods of the DMVR and BDOF, references are made to the description of the embodiments mentioned above, which will not be repeated herein.

In S102, the first motion information is refined based on motion information of a reference picture of the current block, to obtain second motion information of the current block.

Herein, the motion information of the reference picture is used to refine the first motion information and/or for block partitioning.

As can be seen from the above, the motion information in the embodiments of the present disclosure includes information of the reference picture and information of the motion vector, and based on this, the decoder side may obtain the information of the reference picture of the current block from the first motion information of the current block determined above, such as obtaining an index of the reference picture, and then obtain the reference picture of the current block from the reference picture list based on the index.

In some embodiments, if the prediction of the current block in the embodiments of the present disclosure is unidirectional prediction, the current block corresponds to a reference picture list, denoted as RPL0. Next, an index of the reference picture of the current block in the reference picture list RPL0 is determined, and then based on the index, a reference picture corresponding to the index in the reference picture list RPL0 is determined as the reference picture of the current block. Exemplarily, modes of the decoder side determining the index of the reference picture of the current block in the reference picture list RPL0 include at least: Mode 1, the encoder side and the decoder side determine each reference picture in the reference picture list RPL0, such as a first reference picture, as the reference picture of the current block by default, so that the encoder side does not need to indicate the index of the reference picture of the current block in the bitstream. Mode 2, the encoder side writes the index of the reference picture of the current block in the reference picture list RPL0 into the bitstream, so that the decoder side obtains the index of the reference picture of the current block in the reference picture list RPL0 by decoding the bitstream, and then obtains the reference picture of the current block based on the index.

In some embodiments, if the prediction of the current block in the embodiments of the present disclosure is bi-directional prediction, the current block corresponds to two reference picture lists, denoted as RPL0 and RPL1, respectively, and the decoder side determines an index refIdxL0 of a reference picture of the current block in the reference picture list RPL0 and an index refldxL1 of another reference picture of the current block in the reference picture list RPL1, and then based on these two indexes, determines two reference pictures of the current block in the reference picture list RPL0 and the reference picture list RPL1. Exemplarily, modes of the decoder side determining the index of the reference picture of the current block in the reference picture list RPL0 include at least: Mode 1, the encoder side and the decoder side determine each reference picture in the reference picture list RPL0, such as a first reference picture, as the reference picture of the current block by default, so that the encoder side does not need to indicate the index of the reference picture of the current block in the bitstream. Mode 2, the encoder side writes the index of the reference picture of the current block in the reference picture list RPL0 into the bitstream, so that the decoder side obtains the index of the reference picture of the current block in the reference picture list RPL0 by decoding the bitstream, and then obtains the reference picture of the current block based on the index.

Based on the above steps, the decoder side determines the reference picture of the current block, and since the reference pictures are all decoded pictures, their motion information is known. Therefore, the decoder side may directly obtain the motion information of the reference picture, and then determine the second motion information of the current block based on the motion information of the reference picture and the first motion information of the current block determined in the above steps, where the second motion information may be understood as more accurate motion information obtained from refining the first motion information.

In the embodiments of the present disclosure, the motion information of the reference picture plays at least two roles in refining the first motion information: one role is that the motion information of the reference picture directly participates in refining the first motion information, for example, it is used to guide the search process of the second motion information; another role is that in the refinement process of the first motion information, the motion information of the reference picture is used to indicate the partition of the block.

The process in which the decoder side refines the first motion information based on the motion information of the reference picture of the current block to obtain the second motion information of the current block is introduced below.

The embodiments of the present disclosure do not limit the specific process in which the decoder side refines the first motion information based on the motion information of the reference picture to obtain the second motion information of the current block.

In Case 1, if the motion information of the reference picture is used to directly participate in refining the first motion information, the decoder side refines the first motion information to obtain the second motion information by at least several modes shown in the embodiments as follows.

In some embodiments, a template reference region corresponding to a template of the current block is determined in the reference picture, where motion information of the template reference region is known, and motion information of the template of the current block is also known, and therefore, based on the motion information of the template reference region and the motion information of the template of the current block, the first motion information of the current block may be refined, to obtain the second motion information of the current block. For example, a difference value between the motion information of the template reference region and the motion information of the template of the current block is determined, and the difference value is added on the first motion information, to obtain the second motion information of the current block.

In In some embodiments, the above S102 includes steps of S102-A to S102-C as follows.

In S102-A, a reference block corresponding to the current block is determined in the reference picture based on the first motion information.

In S102-B, temporal motion information of the current block is determined as third motion information according to motion information of the reference block based on the current block.

In S102-C, the first motion information is refined based on the third motion information to obtain the second motion information.

In the present embodiment, the decoder side first determines the reference block corresponding to the current block in the reference picture based on the first motion information. Since the motion information of the reference block is known, the decoder side may determine whether the first motion information of the current block is accurate based on the motion information of the reference block. For example, assuming that the reference block and the current block belong to a same object moving as an whole in the picture, and the movement of the whole object is a uniform motion, the reference block may be used as a collocated block of the current block, and the temporal motion information of the current block may be determined based on the motion information of the reference block. For the convenience of description, the temporal motion information is denoted as the third motion information, and then the first motion information is refined based on the third motion information, to achieve accurate refinement of the first motion information.

As can be seen from the above, the first motion information includes information of the motion vector of the current block, and in the embodiments of the present disclosure, the refinement of the first motion information may be understood as the refinement of the motion vector included in the first motion information.

Exemplarily, the decoder side first determines, in the reference picture, the reference block corresponding to the current block, based on the first motion information, where the first motion information of the current block may be unidirectional motion information or bi-directional motion information, and these two cases are introduced below, respectively.

In an example, if the unidirectional prediction is used for the current block, the first motion information of the current block includes unidirectional motion information, that is, the current block corresponds to a reference picture and a motion vector. It is assumed that the reference picture included in the first motion information of the current block curr_block in the current picture curr_pic is a reference picture ref_pic_0 in the reference picture list RPL0, and the motion vector is a first motion vector mv_0. It is assumed that the playback order of the reference picture ref_pic_0 is before the current picture curr_pic. In this way, as illustrated in FIG. 15, the decoder side may locate the corresponding reference block ref_block_0 in the reference picture ref_pic_0 according to the position of the current block curr_block and the first vector mv_0 of the current block. It should be noted that, the current block represented by a dotted box in the reference picture in FIG. 15 may be understood as the collocated block of the current block in the reference picture.

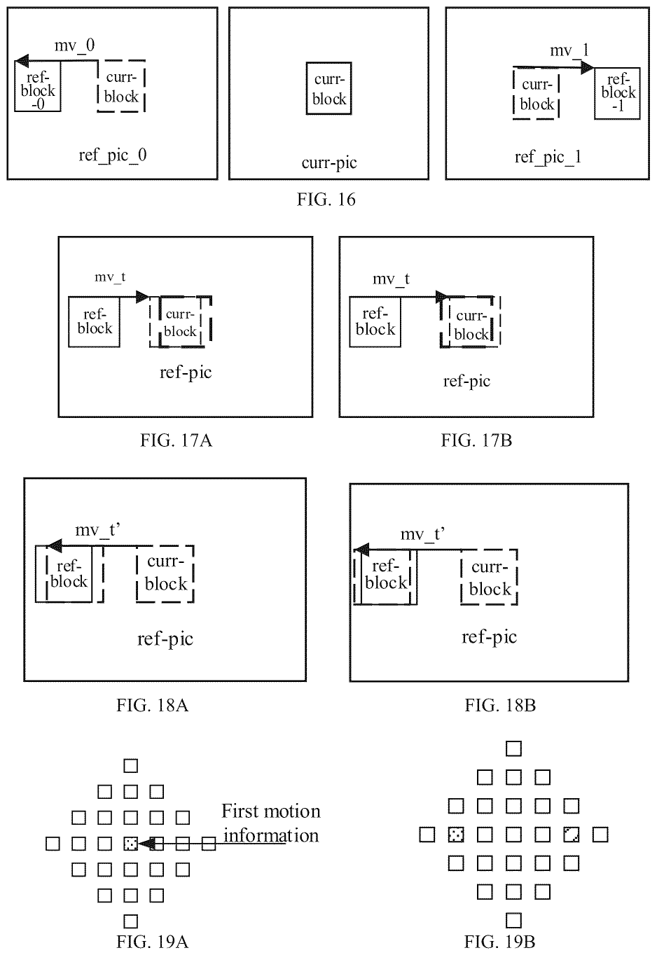

In an example, if the bi-directional prediction is used for the current block, the first motion information of the current block includes bi-directional motion information, that is, the current block corresponds to two reference pictures, denoted as a first reference picture and a second reference picture, and two motion vectors, denoted as a first motion vector and a second motion vector. It is assumed that the first reference picture included in the first motion information of the current block curr_block in the current picture curr_pic is a reference picture ref_pic_0 in the reference picture list RPL0, the first motion vector is mv_0, the second reference picture of the current block is a reference picture ref_pic_1 in the reference picture list RPL1, and the second motion vector is mv_1. It is assumed that the playback order of the first reference picture ref_pic_0 is before the current picture curr_pic, and the playback order of the second reference picture ref_pic_1 is after the current picture curr_pic. In this way, as illustrated in FIG. 16, the decoder side may locate the corresponding first reference block ref_block_0 in the first reference picture ref_pic_0 according to the position of the current block curr_block and the first motion vector mv_0, and may locate the corresponding second reference block ref_block_1 in the second reference picture ref_pic_1 according to the position of the current block curr_block and the second motion vector mv_1.

Based on the above steps, the decoder side determines the reference block of the current block in the reference picture based on the first motion information of the current block, and since the reference pictures are all decoded pictures and motion information thereof is known, the motion information of the reference block may also be obtained.

In the embodiments of the present disclosure, the decoder side may infer the most probable direction of the shift for the first motion vector of the current block according to the motion information of the reference block. Exemplarily, based on the motion information of the reference block, the temporal motion information of the current block is determined and recorded as third motion information, and the third motion information is compared with the first motion information of the current block to determine the most probable direction of the shift for the first motion information.

The implementations for determining the third motion information in the above S102-B include but are not limited to the following modes.

Mode 1, the decoder side uses the current block as the collocated block of the reference block, determines the temporal motion information of the reference block according to the motion information of the reference block, and then determines an inverse value of the temporal motion information as the third motion information.

In an example, if the unidirectional prediction is used for the current block, assuming that the motions within the reference block are the same, the decoder side may infer vector information in the temporal motion information, denoted as mv_t, when the reference block moves from the current position in the reference picture to the current block in the current picture, according to the motion information of the reference block. For example, the decoder side uses a derivation method of the temporal motion information to derive mv_t. Then, an inverse vector-mv_t of mv_t is determined as the motion vector in the third motion information.

Exemplarily, the motion vector mv_0_t of the temporal motion information of the reference block is determined by Formula (10) as follows:

$$mv\_t \_x = - ref\_mv \_x * tb / td , mv\_t \_y = - ref\_mv \_y * tb / td \qquad ( 10 )$$

Herein, (ref_mv_x and ref_mv_y) are the motion vector of the reference block on the x-axis and y-axis, td is a POC distance between the collocated reference picture col_pic and the reference picture col_ref of the collocated block, and tb is a POC distance between the current picture curr_pic and the reference picture curr_ref.

Assuming that the reference block and the current block belong to the same object moving as an whole, and the motion of this object is a uniform linear motion, and the motion information of the reference block is accurate, an absolute value of the motion vector-mv_t in the third motion information determined above is compared with an absolute value of the motion vector mv_0 in the first motion information of the current block, to determine the most probable direction of the shift of the first motion information. For example, if the absolute value of the motion vector-mv_t in the third motion information is less than the absolute value of the motion vector mv_0 in the first motion information of the current block, it means that the reference block can only reach the position of the dotted box illustrated in FIG. 17A according to its current motion, and then, it may be inferred that the motion vector mv_0 of the current block in the first motion information is rather large. For another example, if the absolute value of the motion vector-mv_t in the third motion information is greater than the absolute value of the motion vector mv_0 in the first motion information of the current block, it means that the reference block may reach the position of the dotted box illustrated in FIG. 17B according to its current motion, and then, it may be inferred that the motion vector mv_0 of the current block in the first motion information is rather small.

In an example, if the bi-directional prediction is used for the current block, assuming that the motions within the reference block are the same, the decoder side may infer a motion vector 0 of the first reference block from the first reference picture to the current picture, denoted as mv_0_t, according to the motion information of the first reference block. And the decoder side infers a motion vector 1 of the second reference block from the second reference picture to the current picture, denoted as mv_1_t, according to the motion information of the second reference block. Herein, the motion vector 0 and the motion vector 1 may be derived by using the derivation method of the temporal motion information.

Exemplarily, the motion vector mv_0_t of the temporal motion information of the first reference block is determined by Formula (11) as follows:

$$mv\_ 0 \_t \_x = - ref\_mv \_ 0 \_x * tb 0 / td 0 , mv\_ 0 \_t \_y = - ref\_mv \_ 0 \_y * tb 0 / td 0 \qquad ( 11 )$$

Herein, the ref_mv_0_x and the ref_mv_0_y are motion vectors of the first reference block on the x-axis and the y-axis. td0 is a POC distance between the first collocated reference picture col_pic0 and the first reference picture col_ref0 of the collocated block, and tb0 is a POC distance between the current picture curr_pic and the first reference picture curr_ref0.

Exemplarily, the motion vector mv_1_t of the temporal motion information of the second reference block is determined by Formula (12) as follows:

$$mv\_ 1 \_t \_x = - ref\_mv \_ 1 \_x * tb 1 / td 1 , mv\_ 1 \_t \_y = - ref\_mv \_ 1 \_y * tb 1 / td 1 \qquad ( 12 )$$

Herein, the ref_mv_1_x and the ref_mv_1_y are motion vectors of the second reference block on the x-axis and the y-axis. td1 is a POC distance between the second collocated reference picture col_pic1 and the second reference picture col_ref1 of the collocated block, and tb1 is a POC distance between the current picture curr_pic and the second reference picture curr_ref1.

Next, the decoder side determines the inverse vector −mv_0_t of mv_0_t as a first prediction direction motion vector in the third motion information, and determines the inverse vector −mv_1_t of mv_1_t as a second prediction direction motion vector in the third motion information.

Assuming that the reference block and the current block belong to the same object moving as an whole, and the motion of this object is a uniform linear motion, and the motion information of the reference block is accurate, an absolute value of the motion vector in the third motion information determined above is compared with an absolute value of the motion vector in the first motion information of the current block, to determine the most probable direction of the shift of the first motion information. Exemplarily, since the bi-directional prediction is used for the current block in the embodiments of the present disclosure, it may be determined that the first motion information and the third motion information both include the first prediction direction motion vector and the second prediction direction motion vector, so that the motion information in each direction is compared, respectively. First, the absolute value of the first prediction direction motion vector −mv_0_t in the third motion information is compared with the absolute value of the first prediction direction motion vector mv_0 in the first motion information. For example, if the absolute value of the first prediction direction motion vector −mv_0_t in the third motion information is less than the absolute value of the first prediction direction motion vector mv_0 in the first motion information, it means that when the first reference block moves from the current position in the first reference picture to the current picture according to its current motion vector, it cannot reach the position of the current block currently in the current picture, and then, it may be inferred that the first prediction direction motion vector mv_0 in the first motion information is rather large. For another example, if the absolute value of the first prediction direction motion vector −mv_0_t in the third motion information is greater than the absolute value of the first prediction direction motion vector mv_0 in the first motion information, it means that when the first reference block moves from the current position of the first reference block to the current picture according to its current motion vector, its position in the current picture exceeds the position of the current block in the current picture, and then, it may be inferred that the first prediction direction motion vector mv_0 in the first motion information is rather small. Next, the absolute value of the second prediction direction motion vector −mv_1_t in the third motion information is compared with the absolute value of the second prediction direction motion vector mv_1 in the first motion information. For example, if the absolute value of the second prediction direction motion vector-mv_1_t in the third motion information is less than the absolute value of the second prediction direction motion vector mv_1 in the first motion information, it means that when the second reference block moves from the current position in the second reference picture to the current picture according to its current motion vector, it cannot reach the current block in the current picture, and then, it may be inferred that the second prediction direction motion vector mv_1 in the first motion information is rather large. For another example, if the absolute value of the second prediction direction motion vector −mv_1_t in the third motion information is greater than the absolute value of the second prediction direction motion vector mv_1 in the first motion information, it means that after the second reference block moves from the current position in the second reference picture to the current picture according to its current motion vector, its position in the current picture exceeds the position of the current block in the current picture, and then, it may be inferred that the second prediction direction motion vector mv_1 in the first motion information is rather small.

Mode 2, the decoder side determines the temporal motion information of the current block as the third motion vector according to the motion information of the reference block.

In an example, if the unidirectional prediction is used for the current block, assuming that the motions within the reference block are the same, the decoder side determines the temporal motion information of the current block as the third motion information according to the motion information of the reference block.

Exemplarily, the third motion information is determined by Formula (13) as follows:

$${mv\_t}^{′} \_x = ref\_mv \_x * tb / td , {mv\_t}^{′} \_y = ref\_mv \_y * tb / td \qquad ( 13 )$$

Herein, ref_mv_x and ref_mv_y are motion vectors of the reference block on the x-axis and y-axis, mv_t′_x and mv_t′_y are the first prediction direction motion vector and the second prediction direction motion vector in the third motion information, td is a POC distance between the collocated reference picture col_pic and the reference picture col_ref of the collocated block, and tb is a POC distance between the current picture curr_pic and the reference picture curr_ref.

Assuming that the reference block and the current block belong to the same object moving as an whole, and the motion of this object is a uniform linear motion, and the motion information of the reference block is accurate, the absolute value of the motion vector mv_t′ in the third motion information determined above is compared with the absolute value of the motion vector mv_0 in the first motion information of the current block, to determine the most probable direction of the shift of the first motion information. For example, if the absolute value of the motion vector mv_t′ in the third motion information is less than the absolute value of the motion vector mv_0 in the first motion information of the current block, it means that when the current block moves from the current position in the current picture to the reference picture according to its current motion vector, it may only reach the position of the dotted box illustrated in FIG. 18A, and then, it may be inferred that the motion vector mv_0 of the current block in the first motion information is rather small. For another example, if the absolute value of the motion vector mv_t′ in the third motion information is greater than the absolute value of the motion vector mv_0 in the first motion information of the current block, it means that when the current block moves from the current position in the current picture to the reference picture according to its current motion vector, it may reach the position of the dotted box illustrated in FIG. 18B, and then, it may be inferred that the motion vector mv_0 of the current block in the first motion information is rather large.

In an example, if the bi-directional prediction is used for the current block, the first motion information and the third motion information both include the first prediction direction motion vector and the second prediction direction motion vector. Assuming that the motions within the reference block are the same, the decoder side may infer the motion vector mv_0_t′ of the current block when moving from the current position in the current picture to the first reference picture, according to the motion information of the first reference block. And the decoder side may infer the motion vector mv_1_t′ of the current block when moving from the current position in the current picture to the second reference picture, according to the motion information of the second reference block. Herein, mv_0_t′ is the first prediction direction motion vector in the third motion information, and mv_1_t′ is the second prediction direction motion vector in the third motion information. Herein, mv_0_t′ and mv_1_t′ may be derived by using the derivation method of temporal motion information.

Exemplarily, the first prediction direction motion vector mv_0_t′ in the third motion information is determined by Formula (14) as follows.

$$mv\_ 0 {\_t}^{′} \_x = ref\_mv \_ 0 \_x * tb 0 / td 0 , mv\_ 0 {\_t}^{′} \_y = ref\_mv \_ 0 \_y * tb 0 / td 0 \qquad ( 14 )$$

Herein, the ref_mv_0_x and the ref_mv_0_y are motion vectors of the first reference block on the x-axis and the y-axis. td0 is a POC distance between the first collocated reference picture col_pic0 and the first reference picture col_ref0 of the collocated block, and tb0 is a POC distance between the current picture curr_pic and the first reference picture curr_ref0.

Exemplarily, the second prediction direction motion vector mv_1_t′ in the third motion information is determined by Formula (15) as follows:

$$mv\_ 1 {\_t}^{′} \_x = ref\_mv \_ 1 \_x * tb 1 / td 1 , mv\_ 1 {\_t}^{′} \_y = ref\_mv \_ 1 \_y * tb 1 / td 1 \qquad ( 15 )$$

Herein, the ref_mv_1_x and the ref_mv_1_y are motion vectors of the second reference block on the x-axis and the y-axis. td1 is a POC distance between the second collocated reference picture col_pic1 and the second reference picture col_ref1 of the collocated block, and tb1 is a POC distance between the current picture curr_pic and the second reference picture curr_ref1.

Assuming that the reference block and the current block belong to the same object moving as an whole, and the motion of this object is a uniform linear motion, and the motion information of the reference block is accurate, an absolute value of the motion vector in the third motion information determined above is compared with an absolute value of the motion vector in the first motion information of the current block, to determine the most probable direction of the shift of the first motion information. Exemplarily, first, the absolute value of the first prediction direction motion vector mv_0_t′ in the third motion information is compared with the absolute value of the first prediction direction motion vector mv_0 in the first motion information. For example, if the absolute value of the first prediction direction motion vector mv_0_t′ in the third motion information is less than the absolute value of the first prediction direction motion vector mv_0 in the first motion information, it means that when the current block moves from the current position in the current picture to the first reference picture according to the first prediction direction motion vector mv_0, it cannot reach the position of the current first reference block in the first reference picture, and then, it may be inferred that the first prediction direction motion vector mv_0 in the first motion information is rather large. For another example, if the absolute value of the first prediction direction motion vector mv_0_t′ in the third motion information is greater than the absolute value of the first prediction direction motion vector mv_0 in the first motion information, it means that the position of the current block in the first reference picture after moving from the current position in the current picture to the first reference picture according to the first prediction direction motion vector mv_0 exceeds the current position of the first reference block in the first reference picture, and then, it may be inferred that the first prediction direction motion vector mv_0 in the first motion information is rather small. Next, the absolute value of the second prediction direction motion vector mv_1_t′ in the third motion information is compared with the absolute value of the second prediction direction motion vector mv_1 in the first motion information. For example, if the absolute value of the second prediction direction motion vector mv_1_t′ in the third motion information is less than the absolute value of the second prediction direction motion vector mv_1 in the first motion information, it means that when the current block moves from the current position in the current picture to the second reference picture according to the second prediction direction motion vector mv_1, it cannot reach the current position of the current second reference block in the second reference picture, and then, it may be inferred that the second prediction direction motion vector mv_1 in the first motion information is rather large. For another example, if the absolute value of the second prediction direction motion vector mv_1_t′ in the third motion information is greater than the absolute value of the second prediction direction motion vector mv_1 in the first motion information, it means that the position of the current block in the second reference picture after moving from the current position in the current picture to the second reference picture according to the second prediction direction motion vector mv_1 exceeds the current position of the second reference block in the second reference picture, and then, it may be inferred that the second prediction direction motion vector mv_1 in the first motion information is rather small.

The decoder side determines the third motion information based on the above steps, and then performs the above step S102-C.

In some embodiments, using the third motion information to refine the first motion information mentioned above may result in a larger error, for example, if the object is not in uniform motion. Therefore, in the embodiments of the present disclosure, the decoder side, before refining the first motion information based on the third motion information to obtain the second motion information, first determines a difference value between the first motion information and the third motion information.

The embodiments of the present disclosure do not limit the specific mode in which the decoder side determines the difference value between the first motion information and the third motion information.

In a possible implementation, an absolute value of a difference between the motion vector of the first motion information and the motion vector of the third motion information is determined as the difference value between the first motion information and the third motion information.

Exemplarily, the difference value may be determined by Formula (16) as follows.

$$diff = abs ( mv\_ 0 \_x - mv\_ 0 {\_t}^{′} \_x ) + abs ( mv\_ 0 \_y - mv\_ 0 {\_t}^{′} \_y ) \qquad ( 16 )$$

Herein, mv_0_x and mv_0_y are motion vectors in the first motion information, mv_0_t′_x and mv_0_t′_y are motion vectors in the third motion information, and diff is the difference value between the first motion information and the third motion information.

If the difference value is greater than a preset threshold thr, the step of refining the first motion information based on the third motion information to obtain the second motion information is skipped, while the first motion information is directly refined by DMVR or other modes, to obtain the second motion information. If the difference value is less than or equal to the preset threshold, the above step S102-C is performed to refine the first motion information based on the third motion information, to obtain second motion information.

The embodiments of the present disclosure do not limit the specific mode in which the decoder side refines the first motion information based on the third motion information, to obtain the second motion information.

In some embodiments, the decoder side compares the third motion information with the first motion information to adjust the first motion information based on the third motion information, to obtain refined second motion information. Exemplarily, if it is determined that the first motion information is less than the third motion information, the first motion information may be adaptively increased to obtain the second motion information, for example, when searching for the second motion information surrounding the first motion information, it may be more preferable to search a larger motion vector. Exemplarily, if it is determined that the first motion information is greater than the third motion information, the first motion information may be adaptively decreased to obtain the second motion information, for example, when searching for the second motion information surrounding the first motion information, it may be more preferable to search a smaller motion vector.

In some embodiments, the above S102-C includes steps of S102-C1 and S102-C2 as follows.

In S102-C1, fourth motion information is determined based on the third motion information and the first motion information.

In S102-C2, second motion information is determined based on the fourth motion information.

In this implementation, the implementations of the decoder side determining the fourth motion information based on the third motion information and the first motion information, includes but are not limited to the following modes.

Mode 1, the fourth motion information is determined as an average value of the third motion information and the first motion information.

In an example, if the unidirectional prediction is used for the current block, and the first motion information, the second motion information, and the fourth motion information all include unidirectional motion information, the decoder side may determine the fourth motion information by Formula (17) as follows:

$$mv\_ 0 \_c \_x = ( mv\_ 0 \_x + mv\_ 0 {\_t}^{′} \_x ) / 2 \qquad ( 17 )$$

$$mv\_ 0 \_c \_y = ( mv\_ 0 \_y + mv\_ 0 {\_t}^{′} \_y ) / 2$$

Herein, in Formula (17), mv_0_c_x and mv_0_c_y are motion vectors in the fourth motion information, mv_0_x and mv_0_y are motion vectors in the first motion information, and mv_0_t′_x and mv_0_t′_y are motion vectors in the third motion information.

In an example, if the bi-directional prediction is used for the current block, and the first motion information, the second motion information, and the fourth motion information all include the first prediction direction motion vector and the second prediction direction motion vector, the decoder side may determine the fourth motion information by Formula (18) as follows:

$$mv\_ 0 \_c \_x = ( mv\_ 0 \_x + mv\_ 0 {\_t}^{′} \_x ) / 2 , mv\_ 0 \_c \_y = ( mv\_ 0 \_y + mv\_ 0 {\_t}^{′} \_y ) / 2 \qquad ( 18 )$$

$$mv\_ 1 \_c \_x = ( mv\_ 1 \_x + mv\_ 1 {\_t}^{′} \_x ) / 2 , mv\_ 1 \_c \_y = ( mv\_ 1 \_y + mv\_ 1 {\_t}^{′} \_y ) / 2$$

Herein, in Formula (18), mv_0_c_x and mv_0_c_y are the first prediction direction motion vector in the fourth motion information, mv_1_c_x and mv_1_c_y are the second prediction direction motion vector in the fourth motion information, mv_0_x and mv_0_y are the first prediction direction motion vector in the first motion information, mv_1_x and mv_1_y are the second prediction direction motion vector in the first motion information, mv_0_t′_x and mv_0_t′_y are the first prediction direction motion vector in the third motion information, and mv_1_t′_x and mv_1_t′_y are the second prediction direction motion vector in the third motion information.

Mode 2, weights corresponding to the third motion information and the first motion information are determined, respectively, a weighted average value of the third motion information and the first motion information is determined based on the weights, and then the weighted average value is determined as the fourth motion information.

The embodiments of the present disclosure do not limit the specific mode in which the decoder side determines the weights corresponding to the third motion information and the first motion information.

In an example, a weight corresponding to the third motion information is greater than a weight corresponding to the first motion information.

In an example, a weight corresponding to the third motion information is less than a weight corresponding to the first motion information. This is because the first motion information is an assumption (or prediction) of motion information determined based on related prediction information given by the encoder, and the related prediction information given by the encoder includes a piece of motion information that the encoder considers appropriate, selected by the encoder from a certain candidate list, or a prediction mode selected by the encoder that it considers appropriate. The third motion information is an assumption (or prediction) of motion information inferred by the decoder, such as the motion information of the current block derived by the decoder according to the motion information on the reference picture. In this example, it can be considered that the first motion information is obtained through the encoder selection, and the third motion information is derived based on the motion information of the reference picture, however, the reference picture is not the current picture after all, therefore, in this example, a higher weight may be set for the first motion information and a lower weight may be set for the third motion information.

The decoder side, after determining the weights corresponding to the third motion information and the first motion information, performs a weighted processing on the third motion information and the first motion information, to obtain fourth motion information.

In an example, if the unidirectional prediction is used for the current block, and the first motion information, the second motion information, and the fourth motion information all include the unidirectional motion information, the decoder side may determine the fourth motion information by Formula (19) as follows:

$$mv\_ 0 \_c \_x = ( a 0 * mv\_ 0 \_x + b 0 * mv\_ 0 {\_t}^{′} \_x ) / 2 \qquad ( 19 )$$

$$mv\_ 0 \_c \_y = ( a 0 * mv\_ 0 \_y + b 0 * mv\_ 0 {\_t}^{′} \_y ) / 2$$

Herein, a0 is the weight corresponding to the first motion information, b0 is the weight corresponding to the third motion information, and a0 is greater than b0.

In an example, b0=1−a0.

Exemplarily, a0 may be ¾, ⅝, etc., and b0 may be ¼, 2/8, etc.

Exemplarily, in order to avoid decimals or fractions, if a0 is ¾, the above Formula (19) may be written as Formula (20) as follows:

$$mv\_ 0 \_c \_x = ( 3 * mv\_ 0 \_x + mv\_ 0 {\_t}^{′} \_x ) / 8 \qquad ( 20 )$$

$$mv\_ 0 \_c \_y = ( 3 * mv\_ 0 \_y + mv\_ 0 {\_t}^{′} \_y ) / 8$$

In some embodiments, the division operation in the above formula may also be replaced by a right shift >>.

In an example, if the bi-directional prediction is used for the current block, and the first motion information, the second motion information, and the fourth motion information all include the first prediction direction motion vector and the second prediction direction motion vector, the decoder side may determine the fourth motion information by Formula (21) as follows:

$$mv\_ 0 \_c \_x = ( a 0 * mv\_ 0 \_x + b 0 * mv\_ 0 {\_t}^{′} \_x ) / 2 , mv\_ 0 \_c \_y = ( a 0 * mv\_ 0 \_y + b 0 * mv\_ 0 {\_t}^{′} \_y ) / 2 \qquad ( 21 )$$

$$mv\_ 1 \_c \_x = ( a 1 * mv\_ 1 \_x + b 1 * mv\_ 1 {\_t}^{′} \_x ) / 2 , mv\_ 1 \_c \_y = ( a 1 * mv\_ 1 \_y + b 1 * mv\_ 1 {\_t}^{′} \_y ) / 2$$

Herein, in Formula (21), a0 is the weight corresponding to the first prediction direction motion information (or the first prediction direction motion vector) in the first motion information, and b0 is the weight corresponding to the second prediction direction motion information (or the second prediction direction motion vector) in the first motion information. a1 is the weight corresponding to the first prediction direction motion information (or the first prediction direction motion vector) in the third motion information, and b1 is the weight corresponding to the second prediction direction motion information (or the second prediction direction motion vector) in the third motion information.

In some embodiments, different weights may be set according to specific conditions, for example, different weights may be set according to different prediction modes.

The decoder side, after determining the fourth motion information based on the above steps, performs S102-C2 to determine the second motion information based on the fourth motion information.

In the embodiments of the present disclosure, the specific implementations of the decoder side determining the second motion information based on the fourth motion information in the above S102-C2 include but are not limited to the following modes.

Mode 1, a search center of the second motion information is located at a position corresponding to the fourth motion information, and in this case, the above S102-C2 includes the step of S102-C2-a as follows.

In S102-C2-a, the second motion information is obtained by searching in the reference picture using a position corresponding to the fourth motion information in the reference picture as a search center point of the second motion information.

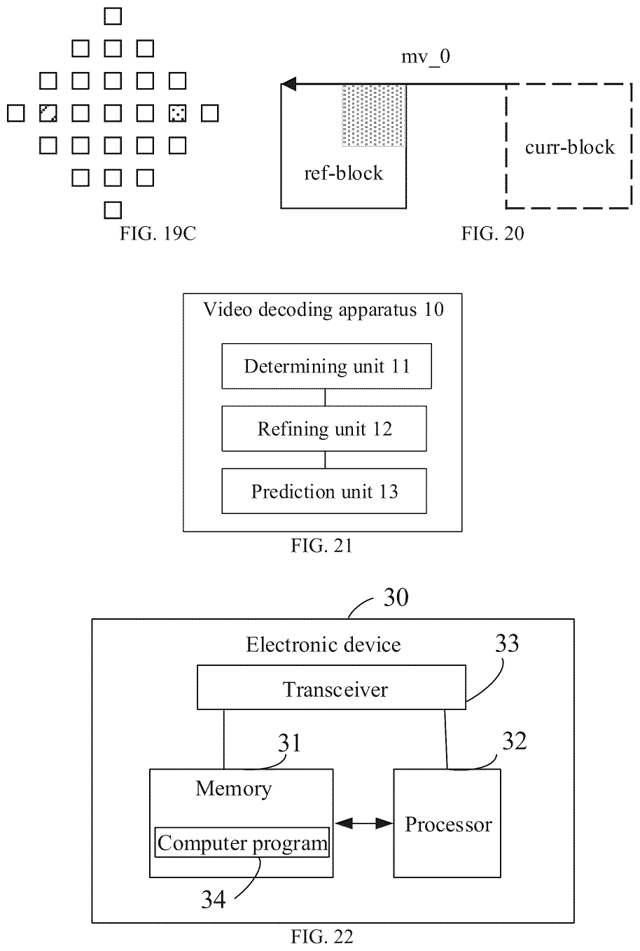

In the embodiments of the present disclosure, the second motion information is obtained by searching surrounding the first motion information. For example, as illustrated in FIG. 19A, the decoder side determines a positioning point of the reference block of the current block in the reference picture based on the first motion information, and the positioning point may be a position of an upper-left corner of the reference block or a center position of the reference block. Next, a search is performed near the positioning point specified by the first motion information, for example, the search is performed using the positioning point as the center, or the search is performed in the same upper, lower, left and right ranges surrounding the positioning point. Exemplarily, in FIG. 19A, a square is a sample position, a point-filled square is a positioning point specified by the first motion information in the reference picture, and a white square is a search position for the second motion information, and motion information corresponding to a position with the lowest cost among these square search points is determined as the second motion information.

As can be seen from the above, there is a problem that the first motion information in the embodiments of the present disclosure may be inaccurate, for example, it is determined that the first motion information is rather large or rather small based on the motion information of the reference picture, and in this case, when the search for the second motion information is performed by using the inaccurate first motion information as the search center, the search for the second motion information is inaccurate. In order to solve this technical problem, in the embodiments of the present disclosure, the third motion information is determined based on the motion information of the reference picture, and then the search center of the second motion information is modified based on the third motion information and the first motion information of the current block. Exemplarily, the fourth motion information is determined based on the third motion information and the first motion information, and then the second motion information is obtained by searching in the reference picture using the position corresponding to the fourth motion information in the reference picture as the search center point of the second motion information. Since the fourth motion information considers the motion information of the reference picture and the first motion information of the current block, using the position specified by the fourth motion information as the search center of the second motion information may improve the accuracy of the search center, thereby improving the search accuracy of the second motion information and improving the decoding prediction effect.

For example, assuming that according to the above analysis, the first motion information is greater than the third motion information, it means that the first motion information is rather large, and in this case, when the search for the second motion information is performed, it is more preferable to search for smaller motion information. As illustrated in FIG. 19B, the point-filled square is the position specified in the reference picture by the first motion information, the square filled with diagonal lines is the position specified in the reference picture by the third motion information, and the position in the reference picture corresponding to the average value (i.e., the fourth motion information) of the third motion information and the first motion information is used as the search center for the second motion information, to obtain the search range as illustrated in FIG. 19B. Compared with FIG. 19A, the search range is shifted to the right, which is preferable to search for smaller motion information, thereby achieving the search accuracy of the second motion information. For another example, if the first motion information is less than the third motion information, it means that the first motion information is rather small, and in this case, when the search for the second motion information is performed, it is more preferable to search for larger motion information. For example, as illustrated in FIG. 19C, the search range of the second motion information is shifted to the left compared to FIG. 19A; and it is preferable to search for larger motion information, thereby achieving the search accuracy of the second motion information.

In the embodiments of the present disclosure, when the unidirectional prediction or the bi-directional prediction is used for the current block, the specific process of determining the search range of the second motion information is basically the same.

In some embodiments, if the unidirectional prediction is used for the current block, the process in which the second motion information is obtained by searching in the reference picture using the position corresponding to the fourth motion information in the reference picture as the search center point of the second motion information may refer to the solutions illustrated in FIG. 19B and FIG. 19C. For example, by using the position corresponding to the fourth motion information in the reference picture as the search center point of the second motion information, the search for motion information is performed within a preset search range near the search center point in the reference picture, and the cost of the motion information corresponding to each searched position point is determined; and then the motion information corresponding to a position point with the smallest cost is determined as the second motion information of the current block. In the unidirectional prediction, the cost of motion information corresponding to each position point may be represented by a matching cost between the motion information of the template of the position point and the motion information of the template of the current block.

In some embodiments, if the bi-directional prediction is used for the current block, the above current block includes a first reference picture and a second reference picture, and the second motion information and the fourth motion information both include first prediction direction motion information and second prediction direction motion information. In this way, the decoder side performs the search for motion information in a preset search range of the first reference picture and a preset search range of the second reference picture, using a position corresponding to the first prediction direction motion information of the fourth motion information in the first reference picture as a search center point of the first prediction direction motion information of the second motion information and using a position corresponding to the second prediction direction motion information of the fourth motion information in the second reference picture as a search center point of the second prediction direction motion information in the second motion information, respectively, to determine a bilateral matching cost of each pair of bilateral motion information searched, where each pair of motion information includes a piece of first prediction direction motion information and a piece of second prediction direction motion information; and then determines the second motion information from the plurality of pairs of bilateral motion information searched based on the bilateral matching cost.

In the bi-directional prediction, it is assumed that the preset search ranges on two sides are the same, both including n possible search position points, that is, each side may search for n possible MVs.

In a possible implementation, when searching, the decoder side may combine n possible MVs corresponding to the first reference picture side with n possible MVs corresponding to the second reference picture side in pairs, to obtain n² pairs of bilateral motion information.

In a possible implementation, when searching the bilateral motion information in the first reference picture and the second reference picture, MVs of the two reference pictures are moved in a mirrored manner when they moving, that is, MVdiff is moved on one side and −MVdiff is moved on another side, on the basis of the MVs corresponding to the respective search center points, and in this case, n pairs of bilateral motion information may be obtained.

When each pair of the plurality of pairs of bilateral motion information is obtained through searching, the bilateral matching cost between the bilateral motion information is determined.

The embodiments of the present disclosure do not limit the specific mode of determining the bilateral matching cost between the bilateral motion information.

By taking an i-th pair of bilateral motion information among the plurality of pairs of bilateral motion information as an example, in a possible implementation, the i-th pair of bilateral motion information includes first prediction direction motion information (for example, a first prediction direction motion vector MV0) and second prediction direction motion information (for example, a second prediction direction motion vector MV1), and since MV0 and MV1 are both vectors, a distance between MV0 and MV1 may be determined based on the vector distance mode, and then the distance may be determined as the bilateral matching cost corresponding to the i-th pair of bilateral motion information.

In a possible implementation, the decoder side may determine a first prediction block in the first reference picture based on first prediction direction motion information of the i-th pair of bilateral motion information, and determine a second prediction block in the second reference picture based on second prediction direction motion information of the i-th pair of bilateral motion information; determine matching costs of the first prediction block and the second prediction block, respectively; and determine a bilateral matching cost of the i-th pair of bilateral motion information based on the matching costs of the first prediction block and the second prediction block. For example, an SAD cost between the first prediction block and the second prediction block is determined as the matching cost between the first prediction block and the second prediction block, and then the matching cost is determined as the bilateral matching cost of the i-th pair of bilateral motion information, or the matching cost is multiplied or divided by a preset coefficient to obtain the bilateral matching cost of the i-th pair of bilateral motion information.

Based on the above steps, the decoder side may determine the bilateral matching cost of each pair of the plurality of pairs of bilateral motion information searched, and then determine a pair of bilateral motion information with a smallest bilateral matching cost among the plurality of pairs of bilateral motion information searched, as the second motion information, to obtain the second motion information as bi-directional motion information.

In the above Mode 1, the specific process in which the second motion information is obtained by searching in the reference picture using the position corresponding to the fourth motion information in the reference picture as the search center point of the second motion information is introduced, and Mode 2 is introduced below.

Mode 2, the cost of the second motion information in the search process is modified according to the fourth motion information, and in this case, the above S102-C2 includes the steps of S102-C2-b1 to S102-C2-b4 as follows.

In S102-C2-b1, search for motion information is performed in the reference picture using a position corresponding to the first motion information in the reference picture as a search center point of the second motion information, to determine a first cost of each piece of candidate motion information searched.

In S102-C2-b2, a cost coefficient corresponding to the candidate motion information is determined based on the candidate motion information and the fourth motion information.

In S102-C2-b3, the first cost is corrected based on the cost coefficient corresponding to the candidate motion information, to obtain a second cost of the candidate motion information.

In S102-C2-b4, the second motion information is determined based on second costs of the plurality of pieces of candidate motion information searched.

In this Mode 2, the first costs of respective pieces of candidate motion information may be searched and determined based on the current first motion information; the cost coefficient determined by the fourth motion information is used to correct the first cost of the candidate motion information to obtain the second cost; and then the second motion information may be selected from respective pieces of candidate motion information based on the second costs of respective pieces of candidate motion information.

Exemplarily, the decoder side first performs a search for motion information in the reference picture using a position corresponding to the first motion information in the reference picture as a search center point of the second motion information, to determine a first cost of each piece of candidate motion information searched. For example, referring to FIG. 19A above, the point-filled square is a positioning point specified by the first motion information in the reference picture, the positioning point is taken as the search center of the second motion information, the motion information at the position corresponding to the white square is denoted as the candidate motion information of the second motion information, and the first cost of each piece of candidate motion information of these pieces of candidate motion information is determined.

Next, for each piece of candidate motion information searched, the cost coefficient corresponding to the candidate motion information is determined based on the candidate motion information and the fourth motion information. For example, the absolute value of the difference between the candidate motion information and the fourth motion information is determined as the cost coefficient corresponding to the candidate motion information. Alternatively, a sum value of a preset value and the absolute value of the difference between the candidate motion information and the fourth motion information is determined as the cost coefficient corresponding to the candidate motion information.

In this way, the first cost of the candidate motion information may be corrected by the above-mentioned determined cost coefficient, to obtain the second cost. For example, the product of the cost coefficient and the first cost of the candidate motion information is determined as the second cost of the candidate motion information.

In the embodiments of the present disclosure, when the unidirectional prediction or the bi-directional prediction is used for the current block, the specific processes of determining the search range of the second motion information are basically the same.

In some embodiments, if the unidirectional prediction is used for the current block, the first motion information and the candidate motion information are both the unidirectional motion information, and as illustrated in FIG. 19A, the decoder side first performs a search for motion information in the preset search range of the reference picture using the position corresponding to the first motion information in the reference picture as the search center point of the second motion information, to determine a first cost of each piece of candidate motion information searched. In the unidirectional prediction, the first cost of each piece of candidate motion information may be represented by the matching cost between the motion information of the template at the position of the candidate motion information and the motion information of the template of the current block. Next, based on each piece of candidate motion information and the fourth motion information, the cost coefficient corresponding to each piece of candidate motion information is determined. For example, the absolute value of the difference between the candidate motion information and the fourth motion information is determined as the cost coefficient corresponding to the candidate motion information. Alternatively, a sum value of a preset value and the absolute value of the difference between the candidate motion information and the fourth motion information is determined as the cost coefficient corresponding to the candidate motion information. Then, the first cost is corrected based on the cost coefficient corresponding to the candidate motion information, to obtain the second cost of the candidate motion information. For example, the product of the cost coefficient and the first cost of the candidate motion information is determined as the second cost of the candidate motion information. In this way, the second costs of the plurality of pieces of candidate motion information searched may be determined, and then the candidate motion information with the smallest second cost among the plurality of pieces of candidate motion information may be determined as the second motion information, in which the second motion information is the unidirectional motion information.

In some embodiments, if the bi-directional prediction is used for the current block, the above current block includes the first reference picture and the second reference picture, and the first motion information, the second motion information, the fourth motion information and the candidate motion information all include the first prediction direction motion information and the second prediction direction motion information. In this case, the above S102-C2-b1 includes a step as follows.

In S102-C2-b11, motion information searching is performed in a preset search range of the first reference picture and a preset search range of the second reference picture, using a position corresponding to the first prediction direction motion information of the first motion information in the first reference picture as a search center point of the first prediction direction motion information of the second motion information and using a position corresponding to the second prediction direction motion information of the first motion information in the second reference picture as a search center point of the second prediction direction motion information of the second motion information, respectively, to determine the first cost of each piece of candidate motion information searched.

In this bi-directional prediction, it is assumed that the preset search ranges on two sides are the same, both including n possible search position points, that is, each side may search for n possible MVs.

In a possible implementation, when performing the search, the decoder side may search for n possible MVs on the first reference picture side using the position corresponding to the first prediction direction motion information in the first motion information in the first reference picture as the search center point of the first prediction direction motion information in the second motion information; and may search for n possible MVs on the second reference picture side using the position corresponding to the second prediction direction motion information in the first motion information in the second reference picture as the search center point of the second prediction direction motion information in the second motion information. The n possible MVs on two sides are combined in pairs to obtain n² pairs of bilateral motion information, and then obtain n² pieces of candidate motion information, and each piece of candidate motion information is bi-directional motion information.

In a possible implementation, when performing the search for the candidate motion information within the preset search range of the first reference picture and the preset search range of the second reference picture using the position corresponding to the first prediction direction motion information in the first motion information in the first reference picture as the search center point of the first prediction direction motion information in the second motion information and using the position corresponding to the second prediction direction motion information in the first motion information in the second reference picture as the search center point of the second prediction direction motion information in the second motion information, the MVs of the two reference pictures are moved in a mirror manner. That is, MVdiff is moved on one side and −MVdiff is moved on another side, on the basis of the MVs corresponding to the respective search center points, and in this case, n pairs of bilateral motion information may be obtained, and then n pieces of candidate motion information may be obtained and each piece of candidate motion information is the bi-directional motion information.

When each piece of candidate motion information of the plurality of pieces of candidate motion information is obtained by searching, a first cost of the candidate motion information is determined, and in this case, the first cost may be the bilateral matching cost. In the embodiments of the present disclosure, the processes of determining the first cost of each piece of candidate motion information are the same, and a piece of candidate motion information is taken as an example for explanation.

In a possible implementation, the candidate motion information includes the first prediction direction motion information (for example, the first prediction direction motion vector MV0) and the second prediction direction motion information (for example, the second prediction direction motion vector MV1), and since MV0 and MV1 are both vectors, a distance between MV0 and MV1 may be determined based on the vector distance mode, and then the distance may be determined as the first cost of the candidate motion information.

In a possible implementation, the decoder side may determine the first prediction block in the first reference picture based on the first prediction direction motion information of the candidate motion information, and determine the second prediction block in the second reference picture based on the second prediction direction motion information of the candidate motion information; determine the matching cost between the first prediction block and the second prediction block; and determine the first cost of the candidate motion information based on the matching cost between the first prediction block and the second prediction block. For example, an SAD cost between the first prediction block and the second prediction block is determined as the matching cost between the first prediction block and the second prediction block, and then the matching cost is determined as the first cost of the candidate motion information, or the matching cost is multiplied or divided by a preset coefficient to obtain the first cost of the candidate motion information.

Next, the cost coefficient corresponding to the candidate motion information is determined based on the candidate motion information and the fourth motion information.

In Mode 2, the search range of the second motion information is not changed, but it is more preferable to select the candidate motion information near the fourth motion information, and then, the first cost of each piece of candidate motion information may be multiplied by a coefficient. For example, a smaller cost coefficient may be set for candidate motion information near the fourth motion information, and a larger cost coefficient may be set for candidate motion information farther from the fourth motion information.

In the embodiments of the present disclosure, if the candidate motion information is the bi-directional motion information, the number of the corresponding cost coefficients may be one or two.

In some embodiments, if the candidate motion information corresponds to a cost coefficient, the absolute value of the difference between the first prediction direction motion information of the candidate motion information and the first prediction direction motion information of the fourth motion information may be determined, denoted as a difference value 1. The absolute value of the difference between the second prediction direction motion information of the candidate motion information and the second prediction direction motion information of the fourth motion information may be determined, denoted as a difference value 2. Based on the difference value 1 and the difference value 2, a difference value 3 is determined, and for example, a sum or an average value of the difference value 1 and the difference value 2 is determined as the difference value 3. Then, based on the difference value 3, a cost coefficient corresponding to the candidate motion information is determined, and for example, the difference value 3 is determined as the cost coefficient corresponding to the candidate motion information, or a sum value of the difference value 3 and a preset value is determined as the cost coefficient corresponding to the candidate motion information. In this way, a second cost of the candidate motion information may be determined according to the determined cost coefficient and the above first cost, and for example, the product of the first cost of the candidate motion information and one cost coefficient corresponding to the candidate motion information may be determined as the second cost of the candidate motion information.

In some embodiments, if the candidate motion information corresponds to two cost coefficients, that is, a first cost coefficient and a second cost coefficient, the above S102-C2-b2 includes steps as follows.

In S102-C2-b21, the first cost coefficient corresponding to first prediction direction motion information of the candidate motion information is determined based on the first prediction direction motion information of the candidate motion information and first prediction direction motion information of the fourth motion information.

In S102-C2-b22, the second cost coefficient corresponding to second prediction direction motion information of the candidate motion information is determined based on the second prediction direction motion information of the candidate motion information and second prediction direction motion information of the fourth motion information.

In the present embodiment, if the cost coefficient corresponding to the candidate motion information is two cost coefficients, the decoder side determines the first cost coefficient corresponding to first prediction direction motion information of the candidate motion information based on the first prediction direction motion information of the candidate motion information and first prediction direction motion information of the fourth motion information, and determines the second cost coefficient corresponding to second prediction direction motion information of the candidate motion information based on the second prediction direction motion information of the candidate motion information and second prediction direction motion information of the fourth motion information.

In the embodiments of the present disclosure, the processes of the decoder side determining the first cost coefficient and determining the second cost coefficient are basically the same.

In a possible implementation, an absolute value of a difference value between the first prediction direction motion information of the candidate motion information and the first prediction direction motion information of the fourth motion information is determined as the first cost coefficient corresponding to the first prediction direction motion information of the candidate motion information. An absolute value of a difference value between the second prediction direction motion information of the candidate motion information and the second prediction direction motion information of the fourth motion information is determined as the second cost coefficient corresponding to the second prediction direction motion information of the candidate motion information.

In a possible implementation, an absolute value of a difference between the i-th prediction direction motion information of the candidate motion information and the i-th prediction direction motion information of the fourth motion information is determined, where i is 1 or 2; and the i-th cost coefficient is determined based on the absolute value of the difference, where the i-th cost coefficient is negatively correlated with the absolute value of the difference. That is, the absolute value 1 of the difference between the first prediction direction motion information of the candidate motion information and the first prediction direction motion information of the fourth motion information is determined, and based on the absolute value 1 of the difference, the first cost coefficient is determined, where the first cost coefficient is negatively correlated with the absolute value 1 of the difference, that is, the greater the absolute value 1 of the difference (i.e., distance), the less the first cost coefficient. The absolute value 2 of the difference between the second prediction direction motion information of the candidate motion information and the second prediction direction motion information of the fourth motion information is determined, and based on the absolute value 2 of the difference, the second cost coefficient is determined, where the second cost coefficient is negatively correlated with the absolute value 2 of the difference, that is, the greater the absolute value 2 of the difference, the less the second cost coefficient.

The embodiments of the present disclosure do not limit the specific mode of determining the i-th cost coefficient based on the absolute value of the difference as above.

In an example, the absolute value of the difference is determined as the i-th cost coefficient. That is, the absolute value 1 of the difference between the first prediction direction motion information of the candidate motion information and the first prediction direction motion information of the fourth motion information is determined as the first cost coefficient, and the absolute value 2 of the difference between the second prediction direction motion information of the candidate motion information and the second prediction direction motion information of the fourth motion information is determined as the second cost coefficient.

In another example, a minimum value among the absolute value of the difference and a first preset value is determined; and based on the minimum value, the i-th cost coefficient is determined. That is, the absolute value 1 of the difference between the first prediction direction motion information of the candidate motion information and the first prediction direction motion information of the fourth motion information is compared with the first preset value, and a minimum value 1 among the absolute value 1 of the difference and the first preset value is determined, and then, the first cost coefficient is determined based on the minimum value 1. Also, the absolute value 2 of the difference between the second prediction direction motion information of the candidate motion information and the second prediction direction motion information of the fourth motion information is compared with the first preset value, and a minimum value 2 among the absolute value 2 of the difference and the first preset value is determined, and then the second cost coefficient is determined based on the minimum value 2.

The embodiments of the present disclosure do not limit the specific value of the above first preset value.

Exemplarily, the first preset value is a value greater than 0.

Optionally, the first preset value is 4.

The embodiments of the present disclosure do not limit the specific mode of determining the i-th cost coefficient based on the minimum value.

For example, the minimum value is determined as the i-th cost coefficient. For example, the above minimum value 1 is determined as the first cost coefficient, and the minimum value 2 is determined as the second cost coefficient.

For another example, a sum of the minimum value and a second preset value is determined as the i-th cost coefficient. For example, a sum of the minimum value 1 and the second preset value is determined as the first cost coefficient, and a sum of the minimum value 2 and the second preset value is determined as the second cost coefficient.

For example, the decoder side determines the first cost coefficient and the second cost coefficient based on Formula (22) as follows:

$$coef\_ 0 = min ( abs ( mv\_ 0 \_x - mv\_ 0 \_c \_x ) + abs ( mv\_ 0 \_y - mv\_ 0 \_c \_y ) , a ) + b \qquad ( 22 )$$

$$coef\_ 1 = min ( abs ( mv\_ 1 \_x - mv\_ 1 \_c \_x ) + abs ( mv\_ 1 \_y - mv\_ 1 \_c \_y ) , a ) + b$$

Herein, coef_0 is the first cost coefficient of the candidate motion information, coef_1 is the second cost coefficient of the candidate motion information, mv_0_x and mv_0_y are the first prediction direction motion information (i.e., the first prediction direction motion vector) of the candidate motion information, and mv_1_x and mv_1_y are the second prediction direction motion information (i.e., the second prediction direction motion vector) of the candidate motion information. mv_0_c_x and mv_0_c_y are the first prediction direction motion information (i.e., the first prediction direction motion vector) of the fourth motion information, and mv_1_c_x and mv_1_c_y are the second prediction direction motion information (i.e., the second prediction direction motion vector) of the fourth motion information. The a is the first preset value, b is the second preset value, and min ( ) is an operation to obtain the minimum value. Optionally, the division operation in the above Formula (22) may also be replaced by a right shift.

The embodiments of the present disclosure do not limit the specific values of the above first preset value a and second preset value b.

Optionally, the first preset value a is 4.

Optionally, the second preset value b is 32.

Based on the above steps, the decoder side, after determining the first cost coefficient and the second cost coefficient of the candidate motion information, corrects the first cost of the candidate motion information based on the first cost coefficient and the second cost coefficient, to obtain the second cost of the candidate motion information.

The embodiments of the present disclosure do not limit the specific mode of the decoder side correcting the first cost of the candidate motion information based on the first cost coefficient and the second cost coefficient to obtain the second cost of the candidate motion information.

In a possible implementation, the first cost coefficient and the second cost coefficient are added together, and multiplied by the first cost of the candidate motion information, to obtain the second cost of the candidate motion information.

In a possible implementation, the first cost of the candidate motion information is multiplied by the first cost coefficient and the second cost coefficient to obtain the second cost of the candidate motion information. Exemplarily, the decoder side obtains the second cost of the candidate motion information by Formula (23) as follows:

$$SAD\_c = SAD * coef\_ 0 * coef\_ 1 \qquad ( 23 )$$

Herein, SAD_c is the second cost of the candidate motion information, SAD is the first cost of the candidate motion information, coef_0 is the first cost coefficient of the candidate motion information, and coef_1 is the second cost coefficient of the candidate motion information.

Based on the above steps, the decoder side may obtain the second cost of each piece of candidate motion information of the plurality of pieces of candidate motion information searched, and the second cost is a cost corrected based on the motion information of the reference picture, and its accuracy is higher than that of the first cost, and then, based on the second cost of each piece of candidate motion information of the plurality of pieces of candidate motion information, the second motion information of the current block is determined from the plurality of pieces of candidate motion information; for example, candidate motion information with a smallest second cost among the plurality of pieces of candidate motion information searched is determined as the second motion information, thereby achieving accurate determination for the second motion information, thereby improving the prediction accuracy of the current block and improving the decoding effect of the decoder side.

The above embodiments all introduce the process of taking the current block as a whole block to perform the whole-block refinement on the first motion information of the whole current block. It should be noted that, the method of the above embodiments is also used for the subblock-based processing, for example, the current block is partitioned into a plurality of sub-blocks, and the first motion information of each sub-block is refined separately in the same way as the first motion information of the above current block, to obtain the second motion information of each sub-block, and then the prediction value of each sub-block is obtained based on the second motion information of each sub-block, and the prediction value of each sub-block constitutes the prediction value of the current block.

The specific process in which the decoder side refines the first motion information to obtain the second motion information if the motion information of the reference picture is used to directly participate in refining the first motion information in Case 1, is introduced in the above embodiments.

Case 2, the motion information of the reference picture in the embodiments of the present disclosure may be used to guide the partition mode of the related block in the refinement process for the first motion information.

In some embodiments, the above S102 includes steps of S102-D to S102-F as follows.

In S102-D, the current block is partitioned into at least one sub-block based on the motion information of the reference picture.

In S102-E, for an i-th sub-block among the at least one sub-block, first motion information of the i-th sub-block is refined to obtain second motion information of the i-th sub-block, where i is a positive integer.

In S102-F, the second motion information of the current block is obtained based on second motion information of N sub-blocks.

Exemplarily, as illustrated in FIG. 20, based on the first motion information of the current block, the reference block of the current block is determined in the reference picture, and motion information of the reference block is acquired, and a motion vector of a point-filled region in the upper-right corner in the reference block is significantly different from that of other regions, and a threshold may be set, and if a difference between the two motion vectors exceeds the threshold, it is considered to be significantly different. Since the current block has a strong correlation with the reference block, in this case, the motion vector of the upper-left corner region of the current block is significantly different from that of other regions, and if the current block is refined as a whole block, the refinement effect is not significant. Therefore, in the embodiments of the present disclosure, when refining the first motion information of the current block, the current block is partitioned into at least one sub-block based on the motion information of the reference picture block, and the motion information for each sub-block is refined separately, so this not only reduces the hardware implementation cost, but also simultaneously provides better flexibility when partitioning into the sub-blocks for refinement, and the MV may be refined separately for each sub-block, thereby achieving the effect of improving the precision of the motion information refinement to a certain extent.

For example, if a part of motion information in the current block is different from the other parts, the refinement effect of the motion information may be improved by partitioning the current block into a plurality of sub-blocks for refinement. Since the distribution of objects in the current picture and the reference picture differs slightly, in the embodiments of the present disclosure, the decoder side indicates the partition of the current block based on the motion information of the reference picture.

The embodiments of the present disclosure do not limit the specific mode of the decoder side partitioning the current block into at least one sub-block based on the motion information of the reference picture.

In some embodiments, the decoder side first determines, in the reference picture, the reference block corresponding to the current block, and then randomly samples motion information of several points in the reference block, and then compares the motion information of the several points, partitions the points of motion information in the several points into a sub-block, and then partitions the reference block into at least one sub-block. Next, the decoder side determines sub-blocks in the current block corresponding to the respective sub-blocks in the reference block, and further partitions the current block into at least one sub-block.

In some embodiments, the above S102-D includes steps of S102-D1 to S102-D4 as follows:

In S102-D1, a reference block in the reference picture corresponding to the current block is determined.

In S102-D2, motion information of M sub-blocks in the reference block that correspond to the M sub-blocks of the current block is acquired, where M is a positive integer greater than 1.

In S102-D3, the acquired motion information of the M sub-blocks is classified, to obtain P classification results, where P is a positive integer less than or equal to M.

In S102-D4, the current block is partitioned into at least one sub-block based on the P classification results.

In this implementation, the decoder side first determines the reference block of the current block in the reference picture based on the first motion information of the current block, and then pre-partitions the current block into M sub-blocks, and the sizes of these M sub-blocks may be the same or different. For example, when the M sub-blocks are all 16×16, or 8×8, or 4×4, etc., or when the width and height of the current block are both 2N, the current block may be partitioned into 4 N×N sub-blocks, or when the size of the current block is N×2N or 2N×N, the current block may be partitioned into 2 N×N sub-blocks. Next, M sub-blocks in the reference block corresponding to the M sub-blocks of the current block are determined, and since the motion information of the reference block is known, the motion information of the M sub-blocks in the reference block corresponding to the M sub-blocks of the current block may be acquired and known by the decoder side. The current block has a strong correlation with the reference block, therefore, the decoder side clusters the acquired motion information of the M sub-blocks in the reference block, to obtain P classification results, and then partitions the current block into at least one sub-block based on the P classification results.

For example, if P=1, it means that the difference in the motion information of respective regions of the current block is not large, and the whole block may be used to refine the first motion information, and the current block is not partitioned, or the current block is partitioned into a sub-block, that is, the current block itself.

For another example, if the P is greater than 1, the current block is partitioned into P sub-blocks based on the respective sub-blocks corresponding to the P classification results, where a sub-block corresponds to a classification result.

Based on the above steps, the decoder side partitions the current block into at least one sub-block, and then refines each sub-block of the at least one sub-block separately, and the refinement process of each sub-block is basically the same, and for ease of description, an i-th sub-block is taken as an example for explanation.

The embodiments of the present disclosure do not limit the specific mode of refining the first motion information of the i-th sub-block to obtain the second motion information of the i-th sub-block.

In a possible implementation, the decoder side refines the first motion information of the i-th sub-block to obtain the second motion information of the i-th sub-block in the above modes such as DMVR and/or BDOF, or the like.

In a possible implementation, the decoder side refines the first motion information of the i-th sub-block according to the motion information of the reference picture, and specifically, the decoder side determines, in the reference picture, the reference block corresponding to the i-th sub-block, based on the first motion information of the i-th sub-block; determines temporal motion information of the i-th sub-block as third motion information corresponding to the i-th sub-block based on the motion information of the reference block of the i-th sub-block; and refines the first motion information of the i-th sub-block based on the third motion information to obtain the second motion information of the i-th sub-block. The specific process of this implementation may refer to the specific description of refining the first motion information of the current block in the above Case 1, and it only needs to replace the above current block with the i-th sub-block, which will not be repeated herein.

The decoder side may determine the second motion information of each sub-block in the current block based on the above steps, and further determine the second motion information of the current block based on the second motion information of at least one sub-block.

For example, the second motion information of the at least one sub-block is determined as the second motion information of the current block, and in this case, the second motion information of the current block includes the second motion information of each sub-block of the at least one sub-block. In this way, when the prediction value of the current block is then determined based on the second motion information of the current block, a prediction value of each sub-block of the at least one sub-block may be determined based on the second motion information of the at least one sub-block, and then the prediction value of the at least one sub-block constitutes the prediction value of the current block.

For another example, an average value of the second motion information of the at least one sub-block is determined as the second motion information of the current block, and in this case, the second motion information of the current block includes motion information of a whole block.

The above embodiments introduce the process of refining the motion information of each sub-block in the current block separately.

In some embodiments, when the decoder side refines the first motion information of the current block, it may perform the refinement for multiple iterations, and in this case, the above S102 includes a step of S102-G as follows.

In S102-G, the first motion information is refined over N iterations based on the motion information of the reference picture of the current block, to obtain the second motion information, where N is a positive integer greater than 1.

The embodiments of the present disclosure do not limit the specific refinement modes used in the refinements of these N iterations.

In a possible implementation, the specific refinement modes used in the refinements of these N iterations are the same.

In a possible implementation, the specific refinement modes used in the refinements of these N iterations are all different.

In a possible implementation, the specific refinement modes used in the refinements of these N iterations are partially the same and partially different.

In some embodiments, the decoder side, when refining the first motion information of the current block over N iterations, partitions the block in a previous iteration in the refinement of a next iteration. For example, in a first iteration, the decoder side refines the first motion information of the current block based on the motion vector refinement method of bi-directional matching based on the whole block. In a second iteration, the current block is partitioned into at least one sub-block, and motion information of respective sub-blocks of the current block that has been refined in the first iteration is refined based on the motion vector refinement of the bi-directional matching based on the sub-blocks, and optionally, the sub-block size in the second iteration may be 16×16. In a third iteration, the sub-blocks in the second iteration are partitioned into at least one sub-block, and the motion information that has been refined in the second iteration is refined based on the motion vector refinement of the bi-directional optical flow based on the sub-blocks, and optionally, the sub-block size in this iteration may be 8×8. Of course, the steps may be further enriched on this basis, such as the refinement of a fourth iteration, for example, the motion information that has been refined in the third iteration is refined based on the motion vector refinement of the bi-directional optical flow based on 4×4 sub-blocks. Optionally, a further refinement may also be performed by using a refinement method such as the motion vector refinement of the bi-directional optical flow based on points, etc. The refinements of the multiple iterations are divided into a plurality of levels from top to bottom to optimize the motion vectors. In the above refinements of the multiple iterations, the sub-block partitioning in at least one iteration is performed based on the motion information of the reference picture, and the specific partition process may refer to the related description of S102-D above, thereby improving the rationality and accuracy of the sub-block partition.

In some embodiments, the above S102-G includes steps of S102-G1 to S102-G3 as follows.

In S102-G1, motion information of each sub-block of at least one sub-block corresponding to a j-th iteration is refined to obtain refined motion information of the at least one sub-block corresponding to the j-th iteration, and in response to j being 1, the sub-block corresponding to the j-th iteration is the current block.

In S102-G2, block partitioning is performed on each sub-block of the at least one sub-block corresponding to the j-th iteration based on the motion information of the reference picture, to obtain at least one sub-block corresponding to a (j+1)-th iteration.

In S102-G3, motion information of each sub-block of the at least one sub-block corresponding to the (j+1)-th iteration is refined; and the process is repeated for N iterations to obtain the second motion information.

In this implementation, the decoder side first refines the first motion information of the current block for a first iteration, to obtain motion information 1 corresponding to the current block that has been refined in the first iteration. Next, it partitions the current block to obtain at least one sub-block 2 corresponding to a second iteration based on the motion information of the reference picture. It refines the motion information of each sub-block 2 of the at least one sub-block 2 corresponding to the second iteration, and in this case, the motion information of the sub-block 2 is the motion information that has been refined in the first iteration, and then it obtains the refined motion information of the at least one sub-block 2 corresponding to the second iteration. Next, it partitions the sub-block 2 to obtain at least one sub-block 3 corresponding to a third iteration based on the motion information of the reference picture. It refines the motion information of each sub-block 3 of the at least one sub-block 3 corresponding to the third iteration, and in this case, the motion information of the sub-block 3 is the motion information that has been refined in the second iteration, and then it obtains the refined motion information of the at least one sub-block 3 corresponding to the third iteration. Next, it partitions the sub-block 3 to obtain at least one sub-block 4 corresponding to a fourth iteration based on the motion information of the reference picture. It refines the motion information of each sub-block 4 of the at least one sub-block 4 corresponding to the fourth iteration, and in this case, the motion information of the sub-block 4 is the motion information that has been refined in the third iteration, and then it obtains the refined motion information of the at least one sub-block 4 corresponding to the fourth iteration. The above steps are repeated; and after the refinements are performed for N iterations, the second motion information of the current block is obtained.

In the embodiments of the present disclosure, the mode of performing block partitioning on the current block or sub-block based on the motion information of the reference picture is basically the same as the above S102-D. For example, the decoder side first determines a reference block in the reference picture corresponding to a second block, where the second block is the current block or a sub-block corresponding to a j-th iteration. Next, it acquires motion information of M sub-blocks in the reference block that correspond to M sub-blocks of the second block, where M is a positive integer greater than 1. Then, it classifies the acquired motion information of the M sub-blocks to obtain P classification results, where P is a positive integer less than or equal to M. Finally, it partitions the second block into at least one sub-block based on the P classification results. For example, it partitions the second block into P sub-blocks based on the respective sub-blocks corresponding to the P classification results. Exemplarily, the related description of the above S102-D may be referred to, which will not be repeated herein.

The embodiments of the present disclosure do not limit the specific method of the decoder side refining the motion information of the sub-block to obtain the refined motion information of the sub-block.

In a possible implementation, the decoder side refines the motion information of the above sub-blocks in modes such as DMVR and/or BDOF, or the like.

In a possible implementation, the decoder side refines the motion information of the sub-block according to the motion information of the reference picture, and specifically, the decoder side determines a reference block in the reference picture that correspond to the sub-block based on the motion information of the sub-block; determines temporal motion information of the sub-block as third motion information corresponding to the sub-block based on the motion information of the reference block of the sub-block; and refines the motion information of the sub-block based on the third motion information to obtain the refined motion information of the sub-block. The specific process of this implementation may refer to the specific description of refining the first motion information of the current block in the above Case 1, and it only needs to replace the above current block with the sub-block, which will not be repeated herein.

The above embodiments introduce the process of refining the first motion information of the current block for multiple passes.

In some embodiments, the decoder side, before refining the first motion information based on the motion information of the reference picture of the current block to obtain the second motion information of the current block, first determines whether the current block satisfies a preset whole-block-based motion vector refinement condition. If it is determined that the current block satisfies the whole-block-based motion vector refinement condition, the first motion information is refined based on the motion information of the reference picture of the current block, to obtain the second motion information of the current block.

In some embodiments, if the current block does not satisfy the whole-block-based motion vector refinement condition, the method in the embodiments of the present disclosure includes steps as follows.
In step 1, block partitioning is performed on the current block based on the motion information of the reference picture to obtain a plurality of first sub-blocks.
In step 2, for any one first sub-block of the plurality of first sub-blocks, it is determined whether the first sub-block satisfies the whole-block-based motion vector refinement condition.
In step 3, in response to that the first sub-block does not satisfy the whole-block-based motion vector refinement condition, block partitioning is performed on the first sub-block based on the motion information of the reference picture to obtain a plurality of second sub-blocks.
In step 4, for any one second sub-block of the plurality of second sub-blocks, it is determined whether the second sub-block satisfies the whole-block-based motion vector refinement condition, and repeat until a partitioned sub-block satisfies the whole-block-based motion vector refinement condition, or until a size of a partitioned sub-block satisfies a preset size.

In this implementation, when the decoder side determines that the current block does not satisfy the whole-block-based motion vector refinement condition, it performs the block partitioning on the current block level by level until the partitioned sub-blocks satisfy the whole-block-based motion vector refinement condition, or when the partitioned sub-blocks do not satisfy the whole-block-based motion vector refinement condition, but the size of the partitioned sub-blocks satisfies the preset size, the sub-block partitioning is stopped.

The embodiments of the present disclosure do not limit the specific content of the above whole-block-based motion vector refinement condition.

In a possible implementation, the whole-block-based motion vector refinement condition may be that the size of the block satisfies a size of a preset threshold, and the preset threshold may be 8×8 or 4×4, etc.

For example, assuming that the above preset threshold is 4×4, if the size of the current block is 32×32, the current block does not satisfy the whole-block-based motion vector refinement condition, then the block partitioning is performed on the current block based on the motion information of the reference picture to obtain a plurality of first sub-blocks. Assuming that the size of the first sub-block is 8×8, the size of the first sub-block does not satisfy the whole-block-based motion vector refinement condition. Next, the block partitioning is performed on the first sub-block to obtain a plurality of second sub-blocks, based on the motion information of the reference picture. Assuming that the size of the second sub-block is 4×4, the second sub-blocks satisfy the whole-block-based motion vector refinement condition, and then, the first motion information of each second sub-block is refined based on the motion information of the reference picture, to obtain the second motion information of each second sub-block.

In a possible implementation, the decoder side determines whether the current block, the first sub-block, or the second sub-block satisfies the whole-block-based motion vector refinement condition through step a to step d as follows.

In step a, a reference block in the reference picture corresponding to the first block is determined, where the first block is the current block, the first sub-block or the second sub-block.

In step b, motion information of M sub-blocks in the reference block that correspond to the M sub-blocks of the first block is acquired, where M is a positive integer greater than 1.

In step c, the required motion information of the M sub-blocks is classified, to obtain P classification results, where P is a positive integer less than or equal to M.

In step d, it is determined whether the first block satisfies the whole-block-based motion vector refinement condition based on the P classification results.

In this implementation, the specific mode in which the decoder side determines whether the current block or the first sub-block or the second sub-block satisfies the whole-block-based motion vector refinement condition is basically the same, and for ease of description, the first block is used to replace the current block or the first sub-block or the second sub-block. Exemplarily, the decoder side first determines the reference block corresponding to the first block in the reference picture, then partitions the first block into M sub-blocks, and acquires motion information of M sub-blocks in the reference block corresponding to the M sub-blocks of the first block. Then, the acquired motion information of the M sub-blocks is classified to obtain the P classification results. The specific implementation processes of the above step a to step c may refer to the specific descriptions of S102-D1 to S102-D3 above, and it only needs to replace the current block in S102-D1 to S102-D3 with the first block, and then the P classification results corresponding to the first block may be obtained.

Finally, it is determined whether the first block satisfies the whole-block-based motion vector refinement condition, based on the P classification results corresponding to the first block.

For example, if P is equal to 1, it means that the motion information of the M sub-blocks in the first block is the same, and the first block does not need to be partitioned, and then it is determined that the first block satisfies the whole-block-based motion vector refinement condition.

For another example, if P is greater than 1, it means that the motion information of the M sub-blocks in the first block is not all the same, and the first block needs to be partitioned, and then it is determined that the first block does not satisfy the whole-block-based motion vector refinement condition.

For example, when determining that the current block does not satisfy the whole-block-based motion vector refinement condition through step a to step d above, the current block is partitioned into a plurality of first sub-blocks based on the motion information of the reference picture, and it is determined whether each first sub-block satisfies the whole-block-based motion vector refinement condition through Step a to Step d above. If a part of the first sub-blocks satisfies the whole-block-based motion vector refinement condition, the motion information of the part of the first sub-blocks is refined based on the motion information of the reference picture. If a part of the first sub-blocks do not satisfy the whole-block-based motion vector refinement condition, each first sub-block in the part of the first sub-blocks is partitioned based on the motion information of the reference picture to obtain a plurality of second sub-blocks. Then, it is determined whether each second sub-block of the plurality of second sub-blocks satisfies the whole-block-based motion vector refinement condition through the Step a to Step d above, and for a second sub-block that satisfies the condition, the motion information of the second sub-block is refined based on the motion information of the reference picture. A second sub-block that does not satisfy the condition is further partitioned, and the above steps are repeated until all sub-blocks satisfy the whole-block-based motion vector refinement condition. Alternatively, until the size of the partitioned sub-block satisfies the preset size, such as 8×8 or 4×4, the block partitioning is no longer performed, and the motion vector refinement mode of the bi-directional optical flow based on sub-blocks is used by default to refine the motion information of the sub-block.

In this implementation, the process of the decoder side partitioning the current block or the first sub-block or the second sub-block based on the motion information of the reference picture is basically the same as the above S102-D. For example, the decoder side first determines the reference block corresponding to the second block in the reference picture, where the second block is the current block or the first sub-block or the second sub-block. Next, motion information of M sub-blocks in the reference block corresponding to the M sub-blocks of the second block is acquired, where M is a positive integer greater than 1. Then, the acquired motion information of the M sub-blocks is classified to obtain P classification results, where P is a positive integer less than or equal to M. Finally, the second block is partitioned into at least one sub-block based on the P classification results, and for example, the second block is partitioned into P sub-blocks based on the respective sub-blocks corresponding to the P classification results. Exemplarily, the related description of the above S102-D may be referred to, which will not be repeated herein.

In conjunction with Case 1 and Case 2, the above embodiments introduce the processes in which the decoder side uses the motion information of the reference picture to refine the first motion information of the current block, and uses the motion information of the reference picture to guide the block partition.

The decoder side, after obtaining the second motion information of the current block based on the above steps, performs a step of S103 as follows.

In S103, a prediction value of the current block is determined based on the second motion information.

Based on the above steps, the decoder side considers the motion information of the reference picture when refining the first motion information of the current block, thereby effectively refining the first motion information of the current block, to obtain the accurate second motion information, and then, in a case of determining the prediction value of the current block based on the accurate second motion information, the prediction accuracy of the current block may be improved, thereby improving the decoding performance of the video.

In some embodiments, if the unidirectional prediction is used for the current block, the second motion information includes a motion vector in a direction, and then based on the motion vector, the prediction block of the current block is determined in the reference picture of the current block, to obtain the prediction value of the current block.

In some embodiments, if bi-directional prediction is used for the current block, the current block has a first reference picture and a second reference picture, and the second motion information includes a first prediction direction motion vector and a second prediction direction motion vector. In this way, the decoder side determines a prediction block 1 in the first reference picture based on the first prediction direction motion vector in the second motion information, and determines a prediction block 2 in the second reference picture based on the second prediction direction motion vector in the second motion information, and then obtains the prediction value of the current block based on the prediction block 1 and the prediction block 2. For example, an average value or a weighted average value of the prediction block 1 and the prediction block 2 is determined as the prediction value of the current block.

In the video decoding method provided in the embodiments of the present disclosure, the decoder side, when decoding the current block, first determines the first motion information of the current block, and then refines the first motion information based on the motion information of the reference picture of the current block, to obtain the second motion information. That is, in the embodiments of the present disclosure, when refining the first motion information, the motion information of the reference picture is considered, thereby effectively refining the first motion information, to obtain the accurate second motion information. Then, when determining the prediction value of the current block based on the accurate second motion information, the prediction accuracy of the current block may be improved, thereby improving the decoding performance of the video.

It should be understood that FIG. 14 to FIG. 20 are merely examples of the present disclosure and should not be construed as limitations to the present disclosure.

The preferred implementations of the present disclosure are described in detail above in connection with the accompanying drawings. However, the present disclosure is not limited to the specific details in the implementations described above. Within the scope of the technical concept of the present disclosure, a variety of simple modifications may be made to the technical solutions of the present disclosure, and these simple modifications all fall within the protection scope of the present disclosure. For example, the various specific technical features described in the specific implementations described above may be combined in any suitable manner without conflict. In order to avoid unnecessary repetition, the various possible combinations are not otherwise described in the present disclosure. For another example, any combination between the various different implementations of the present disclosure is also possible, as long as they do not contradict with the idea of the present disclosure, they should also be regarded as the content disclosed in the present disclosure.

It should also be understood that in the various method embodiments of the present disclosure, the sizes of the serial numbers of the processes described above do not mean an order of execution. The execution order of each process should be determined by its function and internal logic, and should not constitute any limitation on the implementing process of the embodiments of the present disclosure. In addition, in the embodiments of the present disclosure, the term “and/or” is merely used to describe an association relationship between associated objects, which represents that three types of relationships may exist. Specifically, A and/or B may mean three cases where: A exists alone, both A and B exist, and B exists alone. In addition, a character “/” in the present disclosure generally means that associated objects before and after “/” are in an “or” relationship.

The method embodiments of the present disclosure are described in detail above in conjunction with FIG. 14 to FIG. 20, and apparatus embodiments of the present disclosure are described in detail below in conjunction with FIG. 21.

FIG. 21 is a schematic block diagram of a video decoding apparatus provided in an embodiment of the present disclosure, and the video decoding apparatus 10 is applied to the above video decoder.

As illustrated in FIG. 21, the video decoding apparatus 10 includes:
a determining unit 11, configured to determine first motion information of a current block;
a refining unit 12, configured to refine the first motion information based on motion information of a reference picture of the current block to obtain second motion information of the current block; and
a prediction unit 13, configured to determine a prediction value of the current block based on the second motion information.

In some embodiments, the refining unit 12 is specifically configured to: determine, a reference block corresponding to the current block in the reference picture based on the first motion information; determine temporal motion information of the current block as third motion information based on motion information of the reference block; and refine the first motion information based on the third motion information to obtain the second motion information.

In some embodiments, the refining unit 12 is specifically configured to: determine fourth motion information based on the third motion information and the first motion information; and determine the second motion information based on the fourth motion information.

In some embodiments, the refining unit 12 is specifically configured to determine an average value of the third motion information and the first motion information as the fourth motion information.

In some embodiments, the refining unit 12 is specifically configured to: determine weights corresponding to the third motion information and the first motion information, respectively; determine a weighted average value of the third motion information and the first motion information based on the weights; and determine the weighted average value as the fourth motion information.

In some embodiments, a weight of the first motion information is greater than a weight of the third motion information.

In some embodiments, the refining unit 12 is specifically configured to obtain the second motion information by searching in the reference picture using a position corresponding to the fourth motion information in the reference picture as a search center point of the second motion information.

In some embodiments, the reference picture includes a first reference picture and a second reference picture, the second motion information and the fourth motion information both include first prediction direction motion information and second prediction direction motion information, and the refining unit 12 is specifically configured to: perform a search for motion information in a preset search range of the first reference picture and a preset search range of the second reference picture, using a position corresponding to the first prediction direction motion information of the fourth motion information in the first reference picture as a search center point of the first prediction direction motion information of the second motion information and using a position corresponding to the second prediction direction motion information of the fourth motion information in the second reference picture as a search center point of the second prediction direction motion information in the second motion information, respectively, to determine a bilateral matching cost of each pair of bilateral motion information searched, where each pair of bilateral motion information includes a piece of first prediction direction motion information and a piece of second prediction direction motion information; and determine the second motion information from a plurality of pairs of bilateral motion information searched based on the bilateral matching cost.

In some embodiments, the refining unit 12 is specifically configured to: for an i-th pair of bilateral motion information searched, determine a first prediction block in the first reference picture based on first prediction direction motion information of the i-th pair of bilateral motion information, and determine a second prediction block in the second reference picture based on second prediction direction motion information of the i-th pair of bilateral motion information, where i is a positive integer; determine matching costs of the first prediction block and the second prediction block, respectively; and determine a bilateral matching cost of the i-th pair of bilateral motion information based on the matching costs of the first prediction block and the second prediction block.

In some embodiments, the refining unit 12 is specifically configured to determine a pair of bilateral motion information with a minimum bilateral matching cost among the plurality of pairs of bilateral motion information searched, as the second motion information.

In some embodiments, the refining unit 12 is specifically configured to: perform a search for motion information in the reference picture, using a position corresponding to the first motion information in the reference picture as a search center point of the second motion information, to determine a first cost of each piece of candidate motion information searched; determine a cost coefficient corresponding to the candidate motion information based on the candidate motion information and the fourth motion information; correct the first cost based on the cost coefficient corresponding to the candidate motion information, to obtain a second cost of the candidate motion information; and determine the second motion information based on second costs of a plurality of pieces of candidate motion information searched.

In some embodiments, the reference picture includes a first reference picture and a second reference picture, the first motion information, the second motion information, the fourth motion information and the candidate motion information all include first prediction direction motion information and second prediction direction motion information, and the refining unit 12 is specifically configured to: perform the search for the motion information in a preset search range of the first reference picture and a preset search range of the second reference picture, using a position corresponding to the first prediction direction motion information of the first motion information in the first reference picture as a search center point of the first prediction direction motion information of the second motion information, and using a position corresponding to the second prediction direction motion information of the first motion information in the second reference picture as a search center point of the second prediction direction motion information of the second motion information, respectively, to determine the first cost of each piece of candidate motion information searched.

In some embodiments, in response to that the cost coefficient corresponding to the candidate motion information includes a first cost coefficient and a second cost coefficient, the refining unit 12 is configured to: determine the first cost coefficient corresponding to first prediction direction motion information of the candidate motion information based on the first prediction direction motion information of the candidate motion information and first prediction direction motion information of the fourth motion information; and determine the second cost coefficient corresponding to second prediction direction motion information of the candidate motion information based on the second prediction direction motion information of the candidate motion information and second prediction direction motion information of the fourth motion information.

In some embodiments, the refining unit 12 is specifically configured to: determine an absolute value of a difference between the i-th prediction direction motion information of the candidate motion information and the i-th prediction direction motion information of the fourth motion information, where i is 1 or 2; and determine the i-th cost coefficient based on the absolute value of the difference, where the i-th cost coefficient is negatively correlated with the absolute value of the difference.

In some embodiments, the refining unit 12 is specifically configured to: determine a minimum value among the absolute value of the difference and a first preset value; and determine the i-th cost coefficient based on the minimum value.

In some embodiments, the refining unit 12 is specifically configured to determine a sum of the minimum value and a second preset value, as the i-th cost coefficient.

In some embodiments, the refining unit 12 is specifically configured to correct the first cost of the candidate motion information based on the first cost coefficient and the second cost coefficient, to obtain the second cost of the candidate motion information.

In some embodiments, the refining unit 12 is specifically configured to multiply the first cost by the first cost coefficient and the second cost coefficient, to obtain the second cost of the candidate motion information.

In some embodiments, the refining unit 12 is specifically configured to determine candidate motion information with a smallest second cost among the plurality of pieces of candidate motion information selected as the second motion information.

In some embodiments, before refining the first motion information based on the third motion information to obtain the second motion information, the refining unit 12 is further configured to: determine a difference value between the first motion information and the third motion information; and in response to that the difference value is less than or equal to a preset threshold, refine the first motion information based on the third motion information to obtain the second motion information.

In some embodiments, the refining unit 12 is specifically configured to: partition the current block into at least one sub-block based on the motion information of the reference picture; for an i-th sub-block among the at least one sub-block, refine first motion information of the i-th sub-block to obtain second motion information of the i-th sub-block, where i is a positive integer; and obtain the second motion information of the current block based on second motion information of N sub-blocks.

In some embodiments, the refining unit 12 is specifically configured to: determine a reference block corresponding to the i-th sub-block in the reference picture based on the first motion information of the i-th sub-block; determine third motion information for moving the i-th sub-block from a current picture to the reference picture according to motion information of the reference block of the i-th sub-block; and refine the first motion information of the i-th sub-block based on the third motion information, to obtain the second motion information of the i-th sub-block.

In some embodiments, the refining unit 12 is specifically configured to refine the first motion information over N iterations based on the motion information of the reference picture of the current block, to obtain the second motion information, where N is a positive integer greater than 1.

In some embodiments, the refining unit 12 is specifically configured to: refine motion information of each sub-block of at least one sub-block corresponding to a j-th iteration to obtain refined motion information of the at least one sub-block corresponding to the j-th iteration, and where in response to j being equal to 1, the sub-block corresponding to the j-th pass is the current block; perform block partitioning on each sub-block of the at least one sub-block corresponding to the j-th iteration based on the motion information of the reference picture, to obtain at least one sub-block corresponding to a (j+1)-th iteration; and refine motion information of each sub-block of the at least one sub-block corresponding to the (j+1)-th iteration, and repeat the process for N iterations to obtain the second motion information.

In some embodiments, before refining the first motion information based on the motion information of the reference picture of the current block to obtain the second motion information of the current block, the refining unit 12 is further configured to: determine whether the current block satisfies a preset whole-block-based motion vector refinement condition; and in response to that the current block satisfies the whole-block-based motion vector refinement condition, refine the first motion information based on the motion information of the reference picture of the current block to obtain the second motion information of the current block.

In some embodiments, in response to that the current block does not satisfy the whole-block-based motion vector refinement condition, the refining unit 12 is further configured to: perform block partitioning on the current block based on the motion information of the reference picture to obtain a plurality of first sub-blocks; for any one first sub-block of the plurality of first sub-blocks, determine whether the first sub-block satisfies the whole-block-based motion vector refinement condition; in response to that the first sub-block does not satisfy the whole-block-based motion vector refinement condition, perform block partitioning on the first sub-block based on the motion information of the reference picture to obtain a plurality of second sub-blocks; and for any one second sub-block of the plurality of second sub-blocks, determine whether the second sub-block satisfies the whole-block-based motion vector refinement condition, and repeat until a partitioned sub-block satisfies the whole-block-based motion vector refinement condition, or until a size of a partitioned sub-block satisfies a preset size.

In some embodiments, the refining unit 12 is specifically configured to: determine a reference block in the reference picture corresponding to the first block, where the first block is the current block or a first sub-block or a second sub-block; acquire motion information of M sub-blocks in the reference block that correspond to the M sub-blocks of the first block, where M is a positive integer greater than 1; classify the acquired motion information of the M sub-blocks, to obtain P classification results, where P is a positive integer less than or equal to M; and determine whether the first block satisfies the whole-block-based motion vector refinement condition based on the P classification results.

In some embodiments, the refining unit 12 is specifically configured to: in response to P being equal to 1, determine that the first block satisfies the whole-block-based motion vector refinement condition; and in response to P being greater than 1, determine that the first block does not satisfy the whole-block-based motion vector refinement condition.

In some embodiments, the refining unit 12 is specifically configured to: determine a reference block in the reference picture corresponding to the second block, where the second block is any one of the current block, a first sub-block, a second sub-block, and a sub-block corresponding to a j-th pass; acquire motion information of M sub-blocks in the reference block that correspond to the M sub-blocks of the second block, where M is a positive integer greater than 1; classify the acquired motion information of the M sub-blocks, to obtain P classification results, where P is a positive integer less than or equal to M; and partition the second block into at least one sub-block based on the P classification results.

In some embodiments, the refining unit 12 is specifically configured to partition the second block into P sub-blocks, based on respective sub-blocks corresponding to the P classification results.

It should be understood that, the apparatus embodiments and the method embodiments may correspond to each other, and similar descriptions for the apparatus embodiments may refer to the method embodiments, which will not be repeated herein to avoid repetition. Specifically, the apparatus 10 illustrated in FIG. 21 may perform the decoding method for the decoder side of the embodiments of the present disclosure, and the aforementioned and other operations and/or functions of various units in the apparatus 10 are respectively for implementing the corresponding processes in various methods such as the decoding method for the decoder side mentioned above, which will not be repeated herein for the sake of brevity.

The apparatus and system in the embodiments of the present disclosure are described above from the perspective of functional units in combination with the accompanying drawings. It should be understood that the functional units may be implemented in the form of hardware, may be implemented by instructions in the form of software, or may be implemented by a combination of hardware and software units. Specifically, various steps of the method embodiments in the embodiments of the present disclosure may be completed by an integrated logic circuit of hardware and/or instructions in the form of software in the processor. The steps of the method disclosed in combination with the embodiments of the present disclosure may be directly embodied as being executed and completed by a hardware coding processor, or by a combination of hardware and software units in the coding processor. Optionally, the software unit may be located in a mature storage medium in the art, such as a random access memory, a flash memory, a read-only memory, a programmable read-only memory, an electrically erasable programmable memory, a register, etc. The storage medium is located in a memory, and a processor reads information in the memory and completes the steps in the above method embodiments in combination with the hardware of the processor.

FIG. 22 is a schematic block diagram of an electronic device provided in the embodiments of the present disclosure.

As illustrated in FIG. 22, the electronic device 30 may be a video decoder as described in the embodiments of the present disclosure, and the electronic device 30 may include:
a memory 31 and a processor 32, where the memory 31 is used to store a computer program 34 and transmit the computer program 34 to the processor 32. In other words, the processor 32 may invoke and execute the computer program 34 from the memory 31 to implement the method in the embodiments of the present disclosure.

For example, the processor 32 may be configured to perform the steps in the above method 200 according to instructions in the computer program 34.

In some embodiments of the present disclosure, the processor 32 may include, but not limited to:
a general-purpose processor, a digital signal processor (Digital Signal Processor, DSP), an application specific integrated circuit (Application Specific Integrated Circuit, ASIC), a field programmable gate array (Field Programmable Gate Array, FPGA) or other programmable logic devices, a discrete gate or transistor logic device, a discrete hardware component, etc.

In some embodiments of the present disclosure, the memory 31 includes, but not limited to:
a volatile memory and/or a non-volatile memory. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (synch link DRAM, SLDRAM) and a direct rambus random access memory (Direct Rambus RAM, DR RAM).

In some embodiments of the present disclosure, the computer program 34 may be divided into one or more units, and the one or more units are stored in the memory 31 and performed by the processor 32 to complete the methods provided in the present disclosure. The one or more units may be a series of computer program instruction segments capable of completing specific functions, and the instruction segments are used to describe the execution process of the computer program 34 in the electronic device 30.

As illustrated in FIG. 22, the electronic device 30 may further include:
a transceiver 33. The transceiver 33 may be connected to the processor 32 or the memory 31.

Herein, the processor 32 may control the transceiver 33 to communicate with other devices, and specifically, to transmit information or data to other devices, or receive information or data transmitted from other devices. The transceiver 33 may include a transmitter and a receiver. The transceiver 33 may further include antennas, and the number of antennas may be one or more.

It should be understood that the various components in the electronic device 30 are connected via a bus system, where the bus system includes not only a data bus, but also a power bus, a control bus and a status signal bus.

A non-transitory computer storage medium is further provided in the present disclosure, and a computer program is stored on the non-transitory computer storage medium. The computer program, when being executed by a computer, causes the computer to perform the method in the above method embodiments. In other words, a computer program product including instructions is further provided in the embodiments of the present disclosure, and the instructions, when being executed by a computer, cause the computer to perform the method in the above method embodiments.

A bitstream is further provided in the present disclosure, and the bitstream is generated according to the above encoding method.

When the above embodiments are implemented by using software, they may be implemented in the form of a computer program product in whole or in part. The computer program product includes one or more computer instructions. When computer program instructions are loaded and executed on a computer, processes or functions according to the embodiments of the present disclosure are generated in whole or in part. The computer may be a general-purpose computer, a dedicated computer, a computer network, or any other programmable apparatus. The computer instructions may be stored in a non-transitory computer-readable storage medium or transmitted from one non-transitory computer-readable storage medium to another non-transitory computer-readable storage medium, for example, the computer instructions may be transmitted from a website site, computer, server, or data center to another website site, computer, server, or data center via wired (such as coaxial cable, fiber optic, digital subscriber line (DSL)) or wireless (such as infrared, radio, microwave, etc.) means. The non-transitory computer-readable storage medium may be any available medium that can be accessed by the computer, or a data storage device, such as including a server or a data center that integrates one or more available media. The available medium may be a magnetic medium (e.g., a floppy disk, a hard disk or a magnetic tape), an optical medium (e.g., a digital video disk (DVD)) or a semiconductor medium (e.g., a solid state disk (SSD)), etc.

Those ordinary skilled in the art may be aware that steps of units and algorithms of various examples described in conjunction with the embodiments disclosed in the present disclosure can be implemented by electronic hardware, or a combination of computer software and electronic hardware. Whether these functions are performed by hardware or software depends on specific applications and design constraints of the technical solutions. A skilled person may use different methods for each specific application, to implement the described functions, but such implementation should not be considered beyond the scope of the present disclosure.

In several embodiments provided by the present disclosure, it should be understood that the disclosed system, apparatus and method may be implemented in other ways. For example, the apparatus embodiments described above are only illustrative. For example, the division of units is only a logical function division, and there may be other division methods for actual implementations. For example, multiple units or components may be combined or integrated into another system, or some features may be ignored or may not be executed. On the other hand, the coupling or direct coupling or communicative connection between each other as shown or discussed may be indirect coupling or indirect communicative connection via some interfaces, apparatus or units, which may be in the form of electronics, mechanisms, or others.

The units described as separate components may be or may not be physically separated, and the components shown as units may be or may not be physical units, that is, they may be located in one place or distributed across multiple network units. A portion or all of the units may be selected according to actual needs to implement the purposes of the embodiments' schemes. For example, various functional units in various embodiments of the present disclosure may be integrated into one processing unit or the various units may exist physically and separately, or two or more units may be integrated into one unit.

In a first clause, provided is a video decoding method, and the method includes: determining first motion information of a current block; refining the first motion information based on motion information of a reference picture of the current block to obtain second motion information of the current block; and determining a prediction value of the current block based on the second motion information.

In a second clause, according to the method of the first clause, where refining the first motion information based on the motion information of the reference picture of the current block to obtain the second motion information of the current block includes: determining a reference block corresponding to the current block in the reference picture based on the first motion information; determining temporal motion information of the current block as third motion information based on motion information of the reference block; and refining the first motion information based on the third motion information to obtain the second motion information.

In a third clause, according to the method of the second clause, where refining the first motion information based on the third motion information to obtain the second motion information includes: determining fourth motion information based on the third motion information and the first motion information; and determining the second motion information based on the fourth motion information.

In a fourth clause, according to the method of the third clause, where determining the fourth motion information based on the third motion information and the first motion information includes: determining an average value of the third motion information and the first motion information as the fourth motion information.

In a fifth clause, according to the method of the third clause, where determining the fourth motion information based on the third motion information and the first motion information includes: determining weights corresponding to the third motion information and the first motion information, respectively; determining a weighted average value of the third motion information and the first motion information based on the weights; and determining the weighted average value as the fourth motion information.

In a sixth clause, according to the method of the fifth clause, a weight of the first motion information is greater than a weight of the third motion information.

In a seventh clause, according to the method of the third clause, where determining the second motion information based on the fourth motion information includes: obtaining the second motion information by searching in the reference picture using a position corresponding to the fourth motion information in the reference picture as a search center point of the second motion information.

In an eighth clause, according to the method of the seventh clause, where the reference picture includes a first reference picture and a second reference picture, the second motion information and the fourth motion information both include first prediction direction motion information and second prediction direction motion information, and obtaining the second motion information by searching in the reference picture using the position corresponding to the fourth motion information in the reference picture as the search center point of the second motion information includes:
performing a search for motion information in a preset search range of the first reference picture and a preset search range of the second reference picture using a position corresponding to the first prediction direction motion information of the fourth motion information in the first reference picture as a search center point of the first prediction direction motion information of the second motion information and using a position corresponding to the second prediction direction motion information of the fourth motion information in the second reference picture as a search center point of the second prediction direction motion information in the second motion information, respectively, to determine a bilateral matching cost of each pair of bilateral motion information searched, where each pair of bilateral motion information includes a piece of first prediction direction motion information and a piece of second prediction direction motion information; and determining the second motion information from a plurality of pairs of bilateral motion information searched based on the bilateral matching cost.

In a ninth clause, according to the method of the eighth clause, where determining the bilateral matching cost of each pair of bilateral motion information searched includes: for an i-th pair of bilateral motion information searched, determining a first prediction block in the first reference picture based on first prediction direction motion information of the i-th pair of bilateral motion information, and determining a second prediction block in the second reference picture based on second prediction direction motion information of the i-th pair of bilateral motion information, where i is a positive integer; determining matching costs of the first prediction block and the second prediction block, respectively; and determining a bilateral matching cost of the i-th pair of bilateral motion information based on the matching costs of the first prediction block and the second prediction block.

In a tenth clause, according to the method of the ninth clause, where determining the second motion information from the plurality of pairs of bilateral motion information searched based on the bilateral matching cost includes: determining a pair of bilateral motion information with a minimum bilateral matching cost among the plurality of pairs of bilateral motion information searched as the second motion information.

In an eleventh clause, according to the method of the third clause, where determining the second motion information based on the fourth motion information includes: performing a search for motion information in the reference picture using a position corresponding to the first motion information in the reference picture as a search center point of the second motion information, to determine a first cost of each piece of candidate motion information searched; determining a cost coefficient corresponding to the candidate motion information based on the candidate motion information and the fourth motion information; correcting the first cost based on the cost coefficient corresponding to the candidate motion information, to obtain a second cost of the candidate motion information; and determining the second motion information based on second costs of a plurality of pieces of candidate motion information searched.

In a twelfth clause, according to the method of the eleventh clause, where the reference picture includes a first reference picture and a second reference picture, the first motion information, the second motion information, the fourth motion information and the candidate motion information all include first prediction direction motion information and second prediction direction motion information, and performing the search for motion information in the reference picture using the position corresponding to the first motion information in the reference picture as the search center point of the second motion information, to determine the first cost of each piece of candidate motion information searched includes:
performing the search for motion information in a preset search range of the first reference picture and a preset search range of the second reference picture using a position corresponding to the first prediction direction motion information of the first motion information in the first reference picture as a search center point of the first prediction direction motion information of the second motion information and using a position corresponding to the second prediction direction motion information of the first motion information in the second reference picture as a search center point of the second prediction direction motion information of the second motion information, respectively, to determine the first cost of each piece of candidate motion information searched.

In a thirteenth clause, according to the method of the twelfth clause, where in response to that the cost coefficient corresponding to the candidate motion information includes a first cost coefficient and a second cost coefficient, determining the cost coefficient corresponding to the candidate motion information based on the candidate motion information and the fourth motion information includes: determining the first cost coefficient corresponding to first prediction direction motion information of the candidate motion information based on the first prediction direction motion information of the candidate motion information and first prediction direction motion information of the fourth motion information; and determining the second cost coefficient corresponding to second prediction direction motion information of the candidate motion information based on the second prediction direction motion information of the candidate motion information and second prediction direction motion information of the fourth motion information.

In a fourteenth clause, according to the method of the thirteenth clause, where determining an i-th cost coefficient corresponding to i-th prediction direction motion information of the candidate motion information based on i-th prediction direction motion information of the candidate motion information and i-th prediction direction motion information of the fourth motion information includes: determining an absolute value of a difference between the i-th prediction direction motion information of the candidate motion information and the i-th prediction direction motion information of the fourth motion information, where i is 1 or 2; and determining the i-th cost coefficient based on the absolute value of the difference, where the i-th cost coefficient is negatively correlated with the absolute value of the difference.

In a fifteenth clause, according to the method of the fourteenth clause, where determining the i-th cost coefficient based on the absolute value of the difference includes: determining a minimum value among the absolute value of the difference and a first preset value; and determining the i-th cost coefficient based on the minimum value.

In a sixteenth clause, according to the method of the fifteenth clause, where determining the i-th cost coefficient based on the minimum value includes: determining a sum of the minimum value and a second preset value as the i-th cost coefficient.

In a seventeenth clause, according to the method of the thirteenth clause, where correcting the first cost based on the cost coefficient corresponding to the candidate motion information, to obtain the second cost of the candidate motion information includes: correcting the first cost of the candidate motion information based on the first cost coefficient and the second cost coefficient, to obtain the second cost of the candidate motion information.

In an eighteenth clause, according to the method of the seventeenth clause, where correcting the first cost of the candidate motion information based on the first cost coefficient and the second cost coefficient, to obtain the second cost of the candidate motion information includes: multiplying the first cost by the first cost coefficient and the second cost coefficient, to obtain the second cost of the candidate motion information.

In a nineteenth clause, according to the method of the twelfth clause, where determining the second motion information based on the second costs of the plurality of pieces of candidate motion information searched includes: determining candidate motion information with a smallest second cost among the plurality of pieces of candidate motion information selected as the second motion information.

In a twentieth clause, according to the method any one of the second to nineteenth clauses, where before refining the first motion information based on the third motion information to obtain the second motion information, the method includes: determining a difference value between the first motion information and the third motion information; where refining the first motion information based on the third motion information to obtain the second motion information includes: in response to that the difference value is less than or equal to a preset threshold, refining the first motion information based on the third motion information to obtain the second motion information.

In a twenty-first clause, according to the method of any one of the first to nineteenth clauses, where refining the first motion information based on the motion information of the reference picture of the current block to obtain the second motion information of the current block includes: partitioning the current block into at least one sub-block based on the motion information of the reference picture; for an i-th sub-block among the at least one sub-block, refining first motion information of the i-th sub-block to obtain second motion information of the i-th sub-block, where i is a positive integer; and obtaining the second motion information of the current block based on second motion information of N sub-blocks.

In a twenty-second clause, according to the method of the twenty-first clause, where refining the first motion information of the i-th sub-block to obtain the second motion information of the i-th sub-block includes: determining a reference block corresponding to the i-th sub-block in the reference picture based on the first motion information of the i-th sub-block; determining third motion information for moving the i-th sub-block from a current picture to the reference picture according to motion information of the reference block of the i-th sub-block; and refining the first motion information of the i-th sub-block based on the third motion information, to obtain the second motion information of the i-th sub-block.

In a twenty-third clause, according to the method of any one of the first to nineteenth clauses, where refining the first motion information based on the motion information of the reference picture of the current block to obtain the second motion information of the current block includes: refining the first motion information over N iterations based on the motion information of the reference picture of the current block, to obtain the second motion information, where N is a positive integer greater than 1.

In a twenty-fourth clause, according to the method of the twenty-third clause, where refining the first motion information over N iterations based on the motion information of the reference picture of the current block, to obtain the second motion information includes: refining motion information of each sub-block of at least one sub-block corresponding to a j-th iteration to obtain refined motion information of the at least one sub-block corresponding to the j-th iteration, where in response to j being equal to 1, the sub-block corresponding to the j-th iteration is the current block; performing block partitioning on each sub-block of the at least one sub-block corresponding to the j-th iteration based on the motion information of the reference picture, to obtain at least one sub-block corresponding to a (j+1)-th iteration; and refining motion information of each sub-block of the at least one sub-block corresponding to the (j+1)-th iteration, and repeating the process for N iterations to obtain the second motion information.

In a twenty-fifth clause, according to the method of any one of the first to nineteenth clauses, where before refining the first motion information based on the motion information of the reference picture of the current block to obtain the second motion information of the current block, the method includes: determining whether the current block satisfies a preset whole-block-based motion vector refinement condition; where refining the first motion information based on the motion information of the reference picture of the current block to obtain the second motion information of the current block includes: in response to that the current block satisfies the whole-block-based motion vector refinement condition, refining the first motion information based on the motion information of the reference picture of the current block to obtain the second motion information of the current block.

In a twenty-sixth clause, according to the method of the twenty-fifth clause, where in response to that the current block does not satisfy the whole-block-based motion vector refinement condition, the method further includes: performing block partitioning on the current block based on the motion information of the reference picture to obtain a plurality of first sub-blocks; for any one first sub-block of the plurality of first sub-blocks, determining whether the first sub-block satisfies the whole-block-based motion vector refinement condition; in response to that the first sub-block does not satisfy the whole-block-based motion vector refinement condition, performing block partitioning on the first sub-block based on the motion information of the reference picture to obtain a plurality of second sub-blocks; and for any one second sub-block of the plurality of second sub-blocks, determining whether the second sub-block satisfies the whole-block-based motion vector refinement condition, and repeating until a partitioned sub-block satisfies the whole-block-based motion vector refinement condition, or until a size of a partitioned sub-block satisfies a preset size.

In a twenty-seventh clause, according to the method of the twenty-fifth clause, where determining whether a first block satisfies the whole-block-based motion vector refinement condition includes: determining a reference block in the reference picture corresponding to the first block, where the first block is the current block, a first sub-block or a second sub-block; acquiring motion information of M sub-blocks in the reference block that correspond to the M sub-blocks of the first block, where M is a positive integer greater than 1; classifying the acquired motion information of the M sub-blocks, to obtain P classification results, where P is a positive integer less than or equal to M; and determining whether the first block satisfies the whole-block-based motion vector refinement condition based on the P classification results.

In a twenty-eighth clause, according to the method of the twenty-seventh clause, where determining whether the first block satisfies the whole-block-based motion vector refinement condition based on the P classification results includes: in response to P being equal to 1, determining that the first block satisfies the whole-block-based motion vector refinement condition; and in response to P being greater than 1, determining that the first block does not satisfy the whole-block-based motion vector refinement condition.

In a twenty-ninth clause, according to the method of any one of the twenty-first, twenty-fourth and twenty-sixth clauses, where performing block partitioning on a second block based on the motion information of the reference picture includes: determining a reference block in the reference picture corresponding to the second block, where the second block is any one of the current block, a first sub-block, a second sub-block, or a sub-block corresponding to a j-th iteration; acquiring motion information of M sub-blocks in the reference block that correspond to the M sub-blocks of the second block, where M is a positive integer greater than 1; classifying the acquired motion information of the M sub-blocks, to obtain P classification results, where P is a positive integer less than or equal to M; and partitioning the second block into at least one sub-block based on the P classification results.

In a thirtieth clause, according to the method of the twenty-ninth clause, where partitioning the second block into the at least one sub-block based on the P classification results includes: partitioning the second block into P sub-blocks based on respective sub-blocks corresponding to the P classification results.

The above description is only specific implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A video decoding method, comprising:
determining first motion information of a current block;
refining the first motion information based on motion information of a reference picture of the current block to obtain second motion information of the current block; and
determining a prediction value of the current block based on the second motion information.

2. The method according to claim 1, wherein refining the first motion information based on the motion information of the reference picture of the current block to obtain the second motion information of the current block comprises:
determining a reference block corresponding to the current block in the reference picture based on the first motion information;
determining temporal motion information of the current block as third motion information based on motion information of the reference block; and
refining the first motion information based on the third motion information to obtain the second motion information.

3. The method according to claim 2, wherein refining the first motion information based on the third motion information to obtain the second motion information comprises:
determining fourth motion information based on the third motion information and the first motion information; and
determining the second motion information based on the fourth motion information.

4. The method according to claim 3, wherein determining the fourth motion information based on the third motion information and the first motion information comprises:
determining an average value of the third motion information and the first motion information as the fourth motion information.

5. The method according to claim 3, wherein determining the fourth motion information based on the third motion information and the first motion information comprises:
determining weights corresponding to the third motion information and the first motion information, respectively;
determining a weighted average value of the third motion information and the first motion information based on the weights; and
determining the weighted average value as the fourth motion information.

6. The method according to claim 5, wherein a weight of the first motion information is greater than a weight of the third motion information.

7. The method according to claim 3, wherein determining the second motion information based on the fourth motion information comprises:
obtaining the second motion information by searching in the reference picture using a position corresponding to the fourth motion information in the reference picture as a search center point of the second motion information.

8. The method according to claim 7, wherein the reference picture comprises a first reference picture and a second reference picture, the second motion information and the fourth motion information both comprise first prediction direction motion information and second prediction direction motion information, and obtaining the second motion information by searching in the reference picture using the position corresponding to the fourth motion information in the reference picture as the search center point of the second motion information comprises:
performing a search for motion information in a preset search range of the first reference picture and a preset search range of the second reference picture using a position corresponding to the first prediction direction motion information of the fourth motion information in the first reference picture as a search center point of the first prediction direction motion information of the second motion information and using a position corresponding to the second prediction direction motion information of the fourth motion information in the second reference picture as a search center point of the second prediction direction motion information in the second motion information, respectively, to determine a bilateral matching cost of each pair of bilateral motion information searched, wherein each pair of bilateral motion information comprises a piece of first prediction direction motion information and a piece of second prediction direction motion information; and
determining the second motion information from a plurality of pairs of bilateral motion information searched based on the bilateral matching cost.

9. The method according to claim 8, wherein determining the bilateral matching cost of each pair of bilateral motion information searched comprises:
for an i-th pair of bilateral motion information searched, determining a first prediction block in the first reference picture based on first prediction direction motion information of the i-th pair of bilateral motion information, and determining a second prediction block in the second reference picture based on second prediction direction motion information of the i-th pair of bilateral motion information, wherein i is a positive integer;
determining matching costs of the first prediction block and the second prediction block, respectively; and
determining a bilateral matching cost of the i-th pair of bilateral motion information based on the matching costs of the first prediction block and the second prediction block.

10. The method according to claim 9, wherein determining the second motion information from the plurality of pairs of bilateral motion information searched based on the bilateral matching cost comprises:
determining a pair of bilateral motion information with a minimum bilateral matching cost among the plurality of pairs of bilateral motion information searched as the second motion information.

11. The method according to claim 3, wherein determining the second motion information based on the fourth motion information comprises:
performing a search for motion information in the reference picture using a position corresponding to the first motion information in the reference picture as a search center point of the second motion information, to determine a first cost of each piece of candidate motion information searched;
determining a cost coefficient corresponding to the candidate motion information based on the candidate motion information and the fourth motion information;
correcting the first cost based on the cost coefficient corresponding to the candidate motion information, to obtain a second cost of the candidate motion information; and
determining the second motion information based on second costs of a plurality of pieces of candidate motion information searched.

12. The method according to claim 11, wherein the reference picture comprises a first reference picture and a second reference picture, the first motion information, the second motion information, the fourth motion information and the candidate motion information all comprise first prediction direction motion information and second prediction direction motion information, and performing the search for motion information in the reference picture using the position corresponding to the first motion information in the reference picture as the search center point of the second motion information, to determine the first cost of each piece of candidate motion information searched comprises:
performing the search for motion information in a preset search range of the first reference picture and a preset search range of the second reference picture using a position corresponding to the first prediction direction motion information of the first motion information in the first reference picture as a search center point of the first prediction direction motion information of the second motion information and using a position corresponding to the second prediction direction motion information of the first motion information in the second reference picture as a search center point of the second prediction direction motion information of the second motion information, respectively, to determine the first cost of each piece of candidate motion information searched.

13. The method according to claim 12, wherein in response to that the cost coefficient corresponding to the candidate motion information comprises a first cost coefficient and a second cost coefficient, determining the cost coefficient corresponding to the candidate motion information based on the candidate motion information and the fourth motion information comprises:
determining the first cost coefficient corresponding to first prediction direction motion information of the candidate motion information based on the first prediction direction motion information of the candidate motion information and first prediction direction motion information of the fourth motion information; and
determining the second cost coefficient corresponding to second prediction direction motion information of the candidate motion information based on the second prediction direction motion information of the candidate motion information and second prediction direction motion information of the fourth motion information.

14. The method according to claim 13, wherein determining an i-th cost coefficient corresponding to i-th prediction direction motion information of the candidate motion information based on i-th prediction direction motion information of the candidate motion information and i-th prediction direction motion information of the fourth motion information, comprises:
determining an absolute value of a difference between the i-th prediction direction motion information of the candidate motion information and the i-th prediction direction motion information of the fourth motion information, wherein i is 1 or 2; and
determining the i-th cost coefficient based on the absolute value of the difference, wherein the i-th cost coefficient is negatively correlated with the absolute value of the difference.

15. The method according to claim 14, wherein determining the i-th cost coefficient based on the absolute value of the difference comprises:
determining a minimum value among the absolute value of the difference and a first preset value; and
determining the i-th cost coefficient based on the minimum value.

16. The method according to claim 15, wherein determining the i-th cost coefficient based on the minimum value comprises:
determining a sum of the minimum value and a second preset value as the i-th cost coefficient.

17. The method according to claim 13, wherein correcting the first cost based on the cost coefficient corresponding to the candidate motion information, to obtain the second cost of the candidate motion information comprises:
correcting the first cost of the candidate motion information based on the first cost coefficient and the second cost coefficient, to obtain the second cost of the candidate motion information.

18. The method according to claim 17, wherein correcting the first cost of the candidate motion information based on the first cost coefficient and the second cost coefficient, to obtain the second cost of the candidate motion information comprises:
multiplying the first cost by the first cost coefficient and the second cost coefficient, to obtain the second cost of the candidate motion information.

19. The method according to claim 12, wherein determining the second motion information based on the second costs of the plurality of pieces of candidate motion information searched comprises:
determining candidate motion information with a smallest second cost among the plurality of pieces of candidate motion information selected as the second motion information.

20. The method according to claim 2, wherein before refining the first motion information based on the third motion information to obtain the second motion information, the method comprises:
determining a difference value between the first motion information and the third motion information;
wherein refining the first motion information based on the third motion information to obtain the second motion information comprises:
in response to that the difference value is less than or equal to a preset threshold, refining the first motion information based on the third motion information to obtain the second motion information.
